(19) United States
(12) Patent Application Publication
(10) Pub. No.: US 2026/0304306 A1
(43) Pub. Date: Oct. 1, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: NATSUMI KIKUTA, Tokyo (JP)

(21) Appl. No.: 19/575,680

(22) Filed: Mar. 23, 2026

(30) Foreign Application Priority Data
Mar. 31, 2025 (JP) 2025-057899
Jul. 31, 2025 (JP) 2025-128159

(51) Int. Cl. H04W 48/20; G06F 3/12; H04W 84/12

(52) U.S. Cl. CPC H04W 48/20; G06F 3/1203; G06F 3/1226; G06F 3/1236; G06F 3/1287; G06F 3/1288; G06F 3/1292; H04W 84/12

(57) ABSTRACT

A non-transitory computer-readable storage medium storing a program for causing a computer to execute a process including performing as first display control, control to display a list of information about one or more external apparatuses discovered by a search performed by a communication apparatus, accepting a user selection of a connection target from the list, performing, as second display control, when a predetermined condition corresponding to a poor first radio wave condition for wireless communication between a first external apparatus selected by the user and the communication apparatus is not satisfied, control not to display a first notification screen before setting information is transmitted, and when the predetermined condition is satisfied, control to display the first notification screen before the setting information is transmitted, and performing, as first control, control to transmit the setting information.

### BACKGROUND

### Field of the Technology

The present disclosure relates to an information processing apparatus, a control method, and a storage medium.

### Description of the Related Art

A configuration has been known in which an information processing apparatus, such as a smartphone, transmits information for connecting to an access point to a communication apparatus, such as a printer, and the communication apparatus connects to the access point using the information. Japanese Patent Laid-Open No. 2016-127545 describes a configuration in which an information processing apparatus transmits information to a communication apparatus to set a connection mode for determining a connection scheme between the information processing apparatus and the communication apparatus in the communication apparatus.

As schemes become more common in which a communication apparatus transmits information to be used for connecting to an access point, there is a growing need to improve the usability of application programs that perform processing for transmitting the information for connecting to the access point to the communication apparatus.

### SUMMARY

The present disclosure is directed to an improvement in the usability of an application program that performs processing for transmitting information for connecting to an access point to a communication apparatus.

According to an aspect of the present disclosure, a non-transitory computer-readable storage medium storing a program for causing a computer of an information processing apparatus to execute a process including performing, as first display control, control to display a list related to information about one or more external apparatuses discovered by a search performed by a communication apparatus, accepting a user selection of a connection target of the communication apparatus from the list, performing, as second display control, in a case where a predetermined condition corresponding to a state in which a first radio wave condition for wireless communication between a first external apparatus selected by the user and the communication apparatus is poor is not satisfied, control not to display a first notification screen indicating that the first radio wave condition is poor, before setting information for connecting to the first external apparatus is transmitted to the communication apparatus, and in a case where the predetermined condition is satisfied, control to display the first notification screen before the setting information is transmitted to the communication apparatus, and performing, as first control, control to transmit the setting information to the communication apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a communication system.

FIG. 2 is an example of a block diagram of a terminal apparatus and a communication apparatus.

FIGS. 3A and 3B are flowcharts illustrating an example of processing that is performed by the terminal apparatus using a first application.

FIG. 4 illustrates an example of a screen for direct connection.

FIG. 5 illustrates an example of a password input screen.

FIGS. 6A and 6B are diagrams each illustrating an example of a screen for password check.

FIG. 7 is a flowchart illustrating an example of processing that is performed by the terminal apparatus using the first application.

FIG. 8 illustrates an example of a confirmation screen.

FIG. 9 is a flowchart illustrating an example of processing that is performed by the terminal apparatus using the first application.

FIG. 10 is a flowchart illustrating an example of processing that is performed by the terminal apparatus using the first application.

FIG. 11 illustrates an example of a screen for password check.

FIG. 12 is a flowchart illustrating an example of processing that is performed by the terminal apparatus using the first application.

FIGS. 13A to 13C are diagrams each illustrating an example of screens for checking a radio wave strength.

FIG. 14 is a flowchart illustrating an example of processing that is performed by the terminal apparatus using the first application.

FIG. 15 illustrates an example of a screen for checking the radio wave strength.

FIG. 16A is a diagram illustrating an example of a screen displaying an access point (AP) list. FIGS. 16B to 16D are diagrams each illustrating an icon for indicating the magnitude of the radio wave strength of each AP displayed in the list.

FIG. 17 illustrates an example of a screen where the first application displays a method for password check in a chat form.

FIG. 18 illustrates an example of a screen for password check.

FIG. 19 is a flowchart illustrating an example of processing that is performed by the terminal apparatus using the first application.

FIG. 20 is a flowchart illustrating an example of processing that is performed by the terminal apparatus using the first application.

FIG. 21 is a flowchart illustrating an example of processing that is performed by the terminal apparatus using the first application.

FIG. 22 illustrates an example of a screen for checking the radio wave strength.

FIG. 23 is a flowchart illustrating an example of processing that is performed by the terminal apparatus using the first application.

FIG. 24 is a flowchart illustrating an example of processing that is performed by the terminal apparatus using the first application.

FIGS. 25A to 25C are diagrams each illustrating an example of a screen for checking the radio wave strength.

FIG. 26 illustrates an example of a screen for checking the radio wave strength.

### DESCRIPTION OF THE EMBODIMENTS

### First Embodiment

The present embodiment describes an information processing apparatus and a communication apparatus included in a communication system. The information processing apparatus may also be referred to as a terminal apparatus. In the present embodiment, a smartphone is exemplified as the information processing apparatus. However, the disclosure is not limited thereto. Examples of the information processing apparatus include, for instance, a personal computer (PC), a tablet terminal, a personal digital assistant (PDA), a digital camera, and various other devices. In the present embodiment, a printer is exemplified as the communication apparatus. The printer may be an inkjet printer that performs printing using ink, or a laser beam printer that performs printing using toner. Furthermore, the printer may be a full-color printer capable of color printing, or a monochrome printer capable of monochrome printing only. In the present embodiment, the communication apparatus is not limited to a printer, and any device capable of wireless communication with the information processing apparatus can be applied as the communication apparatus. Examples of such a communication apparatus include a copier, a facsimile machine, a scanner, a smartphone, a PC, a tablet terminal, a PDA, a digital camera, a music playback device, a television, a smart speaker, a robotic vacuum cleaner, an automatic cooking pot, a refrigerator, and the like. Moreover, the disclosure can also be applied to a multifunction peripheral equipped with multiple functions, such as copying, faxing, and printing.

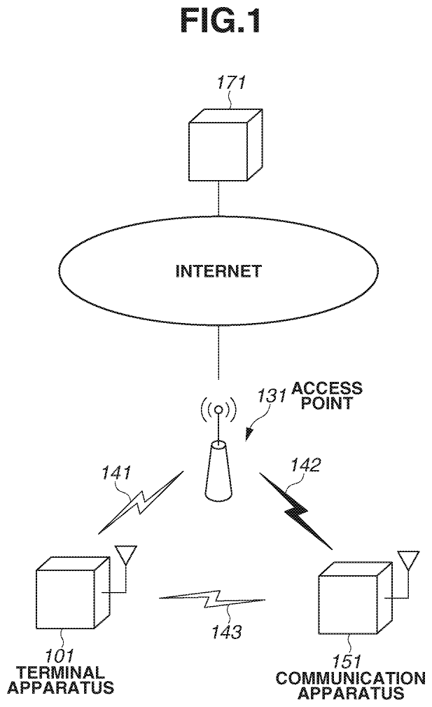

A system configuration for implementing the present embodiment will initially be described. FIG. 1 is a diagram illustrating an example of a configuration of a communication system according to the present embodiment. This communication system includes a communication apparatus 151, a terminal apparatus 101, an access point (AP) 131, and an external server 171.

The terminal apparatus 101 is an information processing apparatus according to the present embodiment. The communication apparatus 151 is a communication apparatus according to the present embodiment. The AP 131 is an AP run by an external apparatus located outside the terminal apparatus 101 and outside the communication apparatus 151. An example of the external apparatus is a wireless local area network (LAN) router. The external server 171 is a server that can provide apparatuses connected to the AP 131 with services via the Internet.

With the communication apparatus 151 and the terminal apparatus 101 connected to the AP 131, a LAN formed by the AP 131 includes the AP 131, the communication apparatus 151, and the terminal apparatus 101. Meanwhile, a wide area network (WAN) includes the AP 131 and the external server 171.

In the present embodiment, the terminal apparatus 101 can communicate with the communication apparatus 151 via the AP 131 when an infrastructure connection to be described below is established. The terminal apparatus 101 can communicate directly with the communication apparatus 151 without passing through the AP 131 when a direct connection to be described below is established. In the following description, a connection to an AP is equivalent to a connection to a network formed by the AP. A single external apparatus may be able to run a plurality of APs and simultaneously form a plurality of networks.

In the present embodiment, a connection 141 between the terminal apparatus 101 and the AP 131 and a connection 142 between the communication apparatus 151 and the AP 131 are connections using a communication method based on an Institute of Electrical and Electronics Engineers (IEEE) 802.11 series standard. Specifically, the communication method based on the IEEE 802.11 series standard refers to Wireless Fidelity (Wi-Fi) (registered trademark). A connection 143 between the terminal apparatus 101 and the communication apparatus 151 is also a connection using the communication method based on the IEEE 802.11 series standard. However, the communication method used for the connection 143 is not limited thereto. For example, Bluetooth® Low Energy, Bluetooth® Classic, Wi-Fi Aware, near-field communication (NFC), and the like may be used. The AP 131 and the external server 171 can communicate via the Internet. With the AP 131 connected to the Internet, the apparatuses (terminal apparatus 101 and communication apparatus 151) connected to the AP 131 can also access the Internet. The connection 141 between the terminal apparatus 101 and the AP 131 and the connection 142 between the communication apparatus 151 and the AP 131 may be connections using a wired LAN.

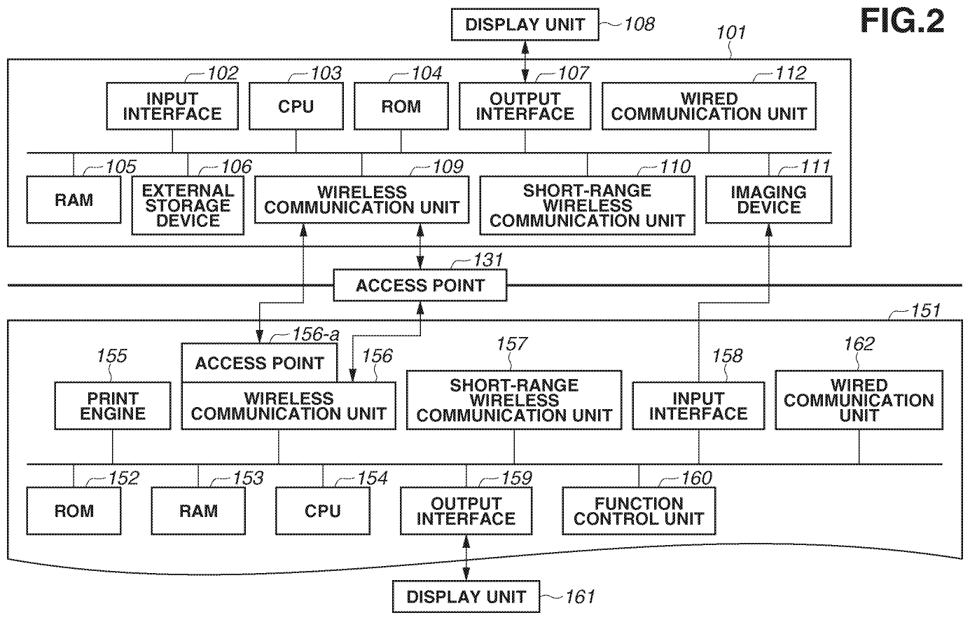

A configuration of the terminal apparatus 101 according to the present embodiment and the communication apparatus 151 that can communicate with the terminal apparatus 101 according to the present embodiment will be described with reference to the block diagram of FIG. 2. While the present embodiment describes the following configuration as an example, the present embodiment is applicable to apparatuses that can communicate with a communication apparatus, and the functions are not particularly limited to those illustrated in this diagram.

The terminal apparatus 101 includes an input interface 102, a central processing unit (CPU) 103, a read-only memory (ROM) 104, a random access memory (RAM) 105, an external storage device 106, an output interface 107, a display unit 108, a wireless communication unit 109, a short-range wireless communication unit 110, an imaging device 111, and a wired communication unit 112. A computer of the terminal apparatus 101 is formed by the CPU 103, the ROM 104, the RAM 105, and the like.

The input interface 102 is an interface for accepting data input and operation instructions from the user, and includes a physical keyboard, buttons, and/or a touchscreen. The output interface 107 to be described below and the input interface 102 may be configured as the same component, and screen output and the acceptance of operations from the user may be performed by the same component.

The CPU 103 is a system control unit and controls the entire operation of the terminal apparatus 101. In the present embodiment, the CPU 103 performs control (display control) of the display content of the display unit 108, etc.

The ROM 104 stores fixed data such as control programs for the CPU 103 to execute, data tables, and operating system (OS) programs. In the present embodiment, the control programs stored in the ROM 104 perform software execution control such as scheduling, task switching, and interrupt handling under the control of a built-in OS stored in the ROM 104. In the present embodiment, the ROM 104 stores a predetermined application program (application) for controlling the communication apparatus 151. An application program is, in other words, application software. The predetermined application is installed on the terminal apparatus 101 from the outside using a store application for installing various applications, for example. The predetermined application is an application provided by the vendor of the communication apparatus 151. In the present embodiment, the predetermined application is an application for communicating with the communication apparatus 151 and configuring connection settings of the communication apparatus 151. In the following description, the predetermined application will be referred to as a first application. The first application may have functions other than the function of configuring the connection settings of the communication apparatus 151. Specific examples of the other functions include a function of transmitting a print job for causing the communication apparatus 151 to perform printing (print job transmission function), and a function of transmitting a scan job for causing the communication apparatus 151 to perform a scan (scan job transmission function). In the present embodiment, processing described to be performed by the OS is, more precisely, processing that the CPU 103 executes based on programs in the OS. Similarly, processing described to be performed by an application is, more precisely, processing that the CPU 103 executes based on a program in the application.

The RAM 105 includes a static RAM (SRAM) that needs a backup power supply. The RAM 105 retains data by using a not-illustrated primary battery for data backup, and can thus store important data such as program control variables in a non-volatile manner. Memory areas for storing setting information about the terminal apparatus 101, management data on the terminal apparatus 101, and the like are also located in the RAM 105. The RAM 105 is also used as a main memory and a work memory of the CPU 103.

The external storage device 106 stores various programs including a print information generation program for generating print information interpretable by the communication apparatus 151, and an information transmission and reception control program for performing transmission and reception with the communication apparatus 151 connected via the wireless communication unit 109. The external storage device 106 also stores various types of information used by these programs, and image data obtained from other information processing apparatuses and the Internet.

The output interface 107 is an interface that performs control for the display unit 108 to display data and issue state notifications of the terminal apparatus 101.

The display unit 108 includes a light-emitting diode (LED) and a liquid crystal display (LCD), and displays data and issues state notifications of the terminal apparatus 101. User input may be accepted via the display unit 108 by displaying a software keyboard including keys such as numeric input keys, mode setting keys, an enter key, a cancel key, and a power key on the display unit 108. In the present embodiment, the display unit 108 is a touchscreen and can accept operations from the user using a finger, a pen, or other operating tools.

The wireless communication unit 109 is a component for wirelessly connecting to apparatuses such as the communication apparatus 151 and the AP 131 and performing data communication. For example, the wireless communication unit 109 may communicate directly with the communication apparatus 151 by wireless communication, or communicate via the AP 131 located outside the terminal apparatus 101 and the communication apparatus 151. In the present embodiment, Wi-Fi, which is a communication method based on the IEEE 802.11 standard, is used as the wireless communication method of the wireless communication unit 109. However, Bluetooth® Classic and the like may be used. In the present embodiment, the wireless LAN refers to a network based on Wi-Fi. In the present embodiment, a connection by a method in which the terminal apparatus 101 and the communication apparatus 151 are directly connected without passing through an external AP will be referred to as a direct connection. A connection by a method in which the terminal apparatus 101 and the communication apparatus 151 are connected via an external AP will be referred to as an infrastructure connection.

The short-range wireless communication unit 110 is a component for performing data communication with apparatuses such as the communication apparatus 151, using a short-range wireless communication method. The short-range wireless communication unit 110 performs communication using a communication method different from a communication method of the wireless communication unit 109. The short-range wireless communication unit 110 can be connected to a short-range wireless communication unit 157 in the communication apparatus 151. Examples of the communication method of the short-range wireless communication unit 110 include Bluetooth® Low Energy, Bluetooth® Classic, Wi-Fi Aware, and NFC.

The imaging device 111 is a device that converts an image captured by an image sensor into digital data.

The digital data is once stored into the RAM 105. The digital data is then converted into a predetermined image format by a program executed by the CPU 103, and stored into the external storage device 106 as image data.

The wired communication unit 112 is a component for connecting to apparatuses such as the communication apparatus 151 and the AP 131 in a wired manner and performing data communication. For example, the wired communication unit 112 communicates via a wired LAN. In the present embodiment, the wired LAN communicates in conformity with the Ethernet standard. The wired communication unit 112 is not restrictive to such a configuration, and may communicate using a Universal Serial Bus (USB) cable, for example. If, for example, the terminal apparatus 101 is a smartphone, the terminal apparatus 101 does not need to include the wired communication unit 112.

The communication apparatus 151 includes a ROM 152, a RAM 153, a CPU 154, a print engine 155, a wireless communication unit 156, a short-range wireless communication unit 157, an input interface 158, an output interface 159, a function control unit 160, a display unit 161, and a wired communication unit 162.

A computer of the communication apparatus 151 is formed by the ROM 152, the RAM 153, the CPU 154, and the like.

The wireless communication unit 156 is a component for wirelessly connecting to apparatuses such as the terminal apparatus 101 and the AP 131 and performing data communication. In the present embodiment, Wi-Fi, which is a communication method based on the IEEE 802.11 standard, is used as the wireless communication method of the wireless communication unit 156. However, Bluetooth® Classic and the like may be used. The wireless communication unit 156 includes, as an internal AP of the communication apparatus 151, an AP 156-a for connecting to apparatuses such as the terminal apparatus 101. This AP 156-a can connect to the wireless communication unit 109 of the terminal apparatus 101. The wireless communication unit 156 may communicate directly with the terminal apparatus 101 via the AP 156-a, or communicate with the terminal apparatus 101 via the AP 131. The AP 156-a may be hardware functioning as an AP. The wireless communication unit 156 may operate as the AP 156-a by using software for functioning as an AP. The communication apparatus 151 may be able to activate a plurality of APs with different service set identifiers (SSIDs) and passwords inside.

The RAM 153 includes a dynamic RAM (DRAM) that needs a backup power supply. The RAM 153 retains data by being powered with a not-illustrated power supply for data backup, and can thus store important data such as program control variables in a non-volatile manner. The RAM 153 is also used as a main memory and a work memory of the CPU 154, functions as a reception buffer for temporarily storing print information received from the terminal apparatus 101 and the like, and stores various types of information.

The ROM 152 stores fixed data such as control programs for the CPU 154 to execute, data tables, and OS programs. In the present embodiment, the control programs stored in the ROM 152 perform software execution control such as scheduling, task switching, and interrupt handling, under the control of a built-in OS stored in the ROM 152. Memory areas for storing data that needs to be retained even without power supply, such as setting information about the communication apparatus 151 and management data on the communication apparatus 151, are also located in the ROM 152.

The CPU 154 is a system control unit and controls the entire operation of the communication apparatus 151.

The print engine 155 forms images on recording media, such as paper, using a recording agent, such as ink, based on information stored in the RAM 153 and print jobs received from the terminal apparatus 101 and the like, and outputs the print result. Since print jobs transmitted from the terminal apparatus 101 and the like have a large amount of transmission data and require high-speed communication, the print jobs are received via the wireless communication unit 156, which is capable of faster communication than the short-range wireless communication unit 157.

The short-range wireless communication unit 157 is a component for communicating with apparatuses such as the terminal apparatus 101 using a short-range wireless communication method. Examples of the communication method of the short-range wireless communication unit 157 include Bluetooth® Low Energy, Bluetooth® Classic, and Wi-Fi Aware.

The input interface 158 is an interface for accepting data input and operation instructions from the user, and includes a physical keyboard, buttons, and/or a touchscreen. The output interface 159 to be described below and the input interface 158 may be configured as the same component, and screen output and the acceptance of operations from the user may be performed by the same component. The output interface 159 is an interface for performing control for the display unit 161 to display data and issue state notifications of the communication apparatus 151.

The function control unit 160 performs function operation management as to whether to simultaneously operate functions of the communication apparatus 151.

The display unit 161 includes an LED and an LCD, and displays data and issues state notifications of the communication apparatus 151. User input may be accepted via the display unit 161 by displaying a software keyboard including keys such as numeric input keys, mode setting keys, an enter key, a cancel key, and a power key on the display unit 161.

The wired communication unit 162 is a component for connecting to apparatuses such as the terminal apparatus 101 and the AP 131 in a wired manner and performing data communication. For example, the wired communication unit 162 communicates via a wired LAN. The wired communication unit 162 is not limited to such a configuration, and may communicate using a USB cable, for example.

### Direct Connection Method

Direct connection refers to a scheme in which apparatuses are directly wirelessly connected (i.e., peer to peer) without passing through an external apparatus such as the AP 131. Direct connection is also referred to as peer-to-peer (P2P) connection. The communication apparatus 151 can operate in a mode for communicating via direct connection (direct connection mode) as one of its connection modes. In Wi-Fi communication, there is a plurality of modes for communication via direct connection, including a software AP mode and Wi-Fi Direct (WFD) mode.

A mode in which direct connection is established by WFD will be referred to as a WFD mode. WFD is a standard stipulated by the Wi-Fi Alliance and included in the IEEE 802.11 series communication standards. In the WFD mode, after communication partner devices are discovered using a device search command, the roles of a P2P group owner (GO) and a P2P client are determined and then the rest of the wireless connection processing is performed. The GO corresponds to a Wi-Fi master station (parent device), and the client corresponds to a Wi-Fi slave station (child device). The role determination corresponds to P2P GO Negotiation, for example. In the WFD mode before the role determination, the communication apparatus 151 is in a state of being neither a master station nor a slave station. Specifically, one of the devices to communicate initially issues a device search command to search for a device to connect to in the WFD mode. When the other device to be the communication partner is discovered, the devices check information about services and functions that can be provided by each other's devices. This device provision information check is optional and not mandatory. This device provision information check phase corresponds to P2P Provision Discovery, for example. By mutually checking the device provision information, which device serves as a P2P client and which device serves as a P2P GO are determined. Once the client and GO are determined, the devices exchange parameters for performing WFD communication. Based on the exchanged parameters, the P2P client and GO perform the rest of the wireless connection processing and Internet Protocol (IP) connection processing therebetween. In the WFD mode, the communication apparatus 151 may operate as a GO without performing the foregoing GO Negotiation. In other words, the communication apparatus 151 may operate in a WFD mode that is the Autonomous GO mode. Examples of the state where the communication apparatus 151 is operating in the WFD mode include where the communication apparatus 151 is operating as a GO with no WFD connection established, and where the communication apparatus 151 is operating as a GO with a WFD connection established.

In the software AP mode, one (for example, the terminal apparatus 101) of the devices to communicate (for example, the terminal apparatus 101 and the communication apparatus 151) becomes a client that plays the role of requesting various services. The other device then implements the Wi-Fi AP functions through software settings. The software AP corresponds to a Wi-Fi master station, and the client corresponds to a Wi-Fi slave station. In the software AP mode, the client searches for the device to be the software AP by using a device search command. When the software AP is discovered, the client and the software AP go through the rest of the wireless connection processing (such as establishing a wireless connection), and then perform IP connection processing (such as assigning IP addresses). Commands and parameters transmitted and received when implementing the wireless connection between the client and the software AP may be ones defined by the Wi-Fi standard. A description thereof will be omitted here.

In the present embodiment, the communication apparatus 151, when establishing and maintaining a direct connection, operates as a master station within the network to which the communication apparatus 151 belongs. A master station is a device that constructs a wireless network and provides a slave station with parameters to be used for connection to the wireless network. Examples of the parameters to be used for connection to a wireless network include parameters related to a channel used by the master station. The slave station receives the parameters, and connects to the wireless network constructed by the master station, using the channel used by the master station. In the direct connection mode, the communication apparatus 151 operates as the master station, and can thus determine which frequency band to use and which channel to use for communication in the direct connection mode. In the present embodiment, the communication apparatus 151 can use channels corresponding to the 2.4-GHz frequency band and channels corresponding to the 5-GHz frequency band for communication in the direct connection mode.

### Infrastructure Connection Method

Infrastructure connection is a connection scheme in which the devices to communicate (for example, the terminal apparatus 101 and the communication apparatus 151) are connected to an AP (for example, the AP 131) that manages the network of the devices, and communicate with each other via the AP. The communication apparatus 151 can also operate in the mode for communicating via infrastructure connection (infrastructure connection mode) as one of its connection modes.

In infrastructure connection, each device searches for the AP by using a device search command. Once the AP is discovered, the device and the AP go through the rest of the wireless connection processing (such as establishing a wireless connection) and then perform IP connection processing (such as assigning IP addresses). Commands and parameters transmitted and received when implementing the wireless connection between the device and the AP may be ones defined by the Wi-Fi standard. A description thereof will be omitted here.

In the present embodiment, when the communication apparatus 151 operates with an infrastructure connection, the AP 131 operates as a master station and the communication apparatus 151 as a slave station. In other words, in the present embodiment, the infrastructure connection refers to a connection between the communication apparatus 151 operating as a slave station and the device operating as the master station. When the communication apparatus 151 has established the infrastructure connection and the terminal apparatus 101 has also established an infrastructure connection with the AP 131, the terminal apparatus 101 and the communication apparatus 151 can communicate with each other via the AP 131. Since the channels to be used for infrastructure connections are determined by the AP 131, the communication apparatus 151 performs the infrastructure connection communication using the channel determined by the AP 131. In the present embodiment, the communication apparatus 151 can use channels corresponding to the 2.4-GHz frequency band and channels corresponding to the 5-GHz frequency band for infrastructure connection communication. The communication apparatus 151 can also use channels corresponding to the Dynamic Frequency Selection (DFS) band in the 5-GHz frequency band for infrastructure connection communication. To communicate with the communication apparatus 151 via the AP 131, the terminal apparatus 101 recognizes and identifies that the communication apparatus 151 belongs to the network that is formed by the AP 131 and to which the terminal apparatus 101 belongs.

### Connection Setup Processing

In the present embodiment, the terminal apparatus 101 configures connection settings (network settings), which are settings for causing the communication apparatus 151 to operate by at least one of the infrastructure connection and direct connection communication methods, using wireless communication with the communication apparatus 151. Connection setup processing according to the present embodiment is also referred to as cableless setup (CLS), since the connection setup processing is performed via wireless communication. The connection setup processing may be performed via wired communication. The terminal apparatus 101 performs the connection setup processing on the communication apparatus 151 when the first application stored in the external storage device 106 or the like is running. The communication apparatus 151 can operate in a connection setup mode (connection setup state) that is a mode for performing the connection setup processing, and performs the connection setup processing in a state of operating in the connection setup mode to be described below. Details of the connection setup mode will be described below.

When causing the communication apparatus 151 to operate in the infrastructure connection mode, the terminal apparatus 101 wirelessly transmits infrastructure setting information, which is setting information for causing the operation in the infrastructure connection mode, to the communication apparatus 151. The infrastructure setting information includes information about the AP 131. Examples of the information about the AP 131 include information about an SSID, password, and frequency bands.

On the other hand, when causing the communication apparatus 151 to operate in the direct connection mode, the terminal apparatus 101 wirelessly transmits direct setting information, which is setting information for causing the operation in the direct connection mode, to the communication apparatus 151. The direct setting information includes instructions to enable the WFD function and cause the communication apparatus 151 to operate as a GO, and enable AP setting of the communication apparatus 151. The terminal apparatus 101 acquires connection information needed to establish a direct connection with the communication apparatus 151 from the communication apparatus 151. Examples of the connection information needed to establish a direct connection with the communication apparatus 151 include information such as the SSID and password of the communication apparatus 151 to operate in the direct connection mode.

In the present embodiment, to transmit the infrastructure setting information and direct setting information and acquire the information needed to establish a direct connection with the communication apparatus 151 in the connection setup processing, a direct connection for connection setup between the terminal apparatus 101 and the communication apparatus 151 is used. In the present embodiment, Wi-Fi based connection setup processing is performed as the direct connection for connection setup. However, wireless communication standards other than Wi-Fi, such as Bluetooth®, may be used. Alternatively, wired communication standards such as a wired LAN and USB may be used for the direct connection for connection setup.

After a Wi-Fi based infrastructure connection or direct connection is established between the terminal apparatus 101 and the communication apparatus 151 by the connection setup processing, the terminal apparatus 101 and the communication apparatus 151 can communicate with each other via the established connection. Specifically, for example, the terminal apparatus 101 can transmit a print job for causing the communication apparatus 151 to perform printing or a scan job for causing the communication apparatus 151 to perform a scan to the communication apparatus 151 via the established connection. In the present embodiment, the connection setup processing enables the communication apparatus 151 to operate in either the infrastructure connection mode or the direct connection mode. However, such a configuration is not restrictive. For example, the connection setup processing may be configured to be only capable of causing the communication apparatus 151 to operate in the infrastructure connection mode (i.e., not capable of causing the communication apparatus 151 to operate in the direct connection mode).

### Connection Setup Mode

The communication apparatus 151 can operate in the connection setup mode. Examples of the trigger for the communication apparatus 151 to start operating in the connection setup mode include the user pressing a connection setup mode button, and the communication apparatus 151 being activated (powered on) for the first time after delivery. The connection setup mode button may be a hardware button disposed on the communication apparatus 151, or a software button that the communication apparatus 151 displays on the display unit 161.

Starting the operation in the connection setup mode, the communication apparatus 151 enables Wi-Fi communication. Specifically, as Wi-Fi communication enabling processing, the communication apparatus 151 enables an internal AP (connection setup AP) of the communication apparatus 151 dedicated for the connection setup mode. This enables the communication apparatus 151 to establish a Wi-Fi based direct connection with the terminal apparatus 101. At least part of the connection information (SSID and password) for connecting to the connection setup AP is stored in advance in the first application installed on the terminal apparatus 101. In other words, the terminal apparatus 101 recognizes as least part of the connection information for connecting to the connection setup AP in advance. Unlike the connection information about the AP to be enabled in the direct connection mode, at least part of the connection information for connecting to the connection setup AP is therefore not freely configurable by the user. The connection information for connecting to the connection setup AP will hereinafter be referred to as the SSID of the connection setup AP. Details of the SSID of the connection setup AP according to the present embodiment will now be described.

In the present embodiment, the SSID of the connection setup AP includes a character string common to a plurality of models, a character string common to devices of an identical model, and an individual character string. The character string common to a plurality of models is a character that is common between a predetermined model provided by a predetermined vendor and other models provided by the predetermined vendor. Specifically, the character string common to a plurality of models is a character string including a character string indicating the vendor name. The character string indicating the vendor name is not limited to a character string consisting of the vendor name, but may be any character string including the vendor name. Such a configuration is not restrictive. For example, a character string that does not include the character string indicating the vendor name but is assigned on a vendor-by-vendor basis may be used. The character string common to devices of an identical model corresponds to a character string that is common between devices of a predetermined model provided by a predetermined vendor and not between the predetermined model provided by the predetermined vendor and other models provided by the predetermined vendor. The character string common to devices of an identical model will hereinafter be referred to as a model-specific common character string. Specifically, the model-specific common character string is a character string including a character string indicating the model name. The character string indicating the model name is not limited to a character string consisting of the model name, but may be any character string including the model name. Such a configuration is not restrictive. For example, a character string that does not include the character string indicating the model name but is assigned on a model-by-model may be used.

The individual character string corresponds to a character string that differs from one communication apparatus to another. Specifically, the individual character string refers to a character string such as the device's serial number and a random character string that differs from one communication apparatus to another. However, such a configuration is not restrictive. A character string including a character string that varies each time the connection setup mode is activated may be used. In the present embodiment, the order of the character strings constituting the SSID of the connection setup AP is: the character string common to a plurality of models, the individual character string, and the model-specific common character string. However, such a configuration is not restrictive, and any order may be employed. In the present disclosure, the SSID of the connection setup AP does not need to include all the three types of character strings that are the character string common to a plurality of models, the individual character string, and the model-specific common character string. For example, a character string including two of the three types of character strings may be used. A character string freely determined by the user may be used.

The first application retains at least a part of the character string of the SSID in advance, and notifies the OS of the at least part of the character string of the SSID, whereby the OS executes a communication apparatus search. In the present embodiment, the character string retained by the first application in advance is the character string indicating the vendor name. The character string indicating the vendor name is, in other words, at least a part of the character strings constituting the SSID, and is a character string common to a plurality of models. The character string retained by the first application in advance is not limited to the character string common to a plurality of models, and may be the model-specific common character string or the individual character string. In the present disclosure, the first application does not need to retain at least a part of the character string of the SSID in advance. Specifically, the first application may accept input of at least a part of the character string of the SSID from the user, recognize the input character string itself, and notify the OS of the character string itself.

The connection setup AP may be configured without an encryption method so that this AP can be connected to without a password. In the connection setup mode, the communication apparatus 151 and the terminal apparatus 101 may be connected not by normal Wi-Fi but by WFD. More specifically, the communication apparatus 151 may operate as a GO and receive a setup command from the terminal apparatus 101 by WFD communication. In the connection setup mode, the communication apparatus 151 may enable communication other than Wi-Fi communication, such as Bluetooth® Low Energy communication. In other words, the communication apparatus 151 may perform the connection setup processing using a communication method other than Wi-Fi.

### Registration of Communication Apparatus in Application

In the present embodiment, the first application can register the communication apparatus 151 with itself by acquiring information about the communication apparatus 151 from the communication apparatus 151.

Examples of the information about the communication apparatus 151 include capability information about the communication apparatus 151, identification information (such as a media access control [MAC] address) about the communication apparatus 151, and model information about the communication apparatus 151. Specifically, the capability information about the communication apparatus 151 includes information listing functions supported by the communication apparatus 151, information about consumables (inks and sheets) usable by the communication apparatus 151, and information indicating the printing method of the communication apparatus 151. The first application selects one apparatus to serve as a communication partner of the first application from one or more communication apparatuses 151 registered with the first application. The communication apparatus 151 currently selected as the apparatus to serve as the communication partner of the first application will hereinafter be referred to as a selected communication apparatus 151. The apparatus to serve as the communication partner of the first application may be selected by accepting the user selection from among the one or more communication apparatuses 151 registered with the first application, or automatically selected by the first application based on a predetermined criterion. The apparatus to serve as the communication partner of the first application may be changed, for example, by accepting the user selection from among the one or more communication apparatuses 151 registered with the first application. In the present embodiment, the first application transmits various jobs, including print jobs and scan jobs, to the selected communication apparatus 151. In other words, the selected communication apparatus 151 is an apparatus serving as a transmission destination of various jobs.

### Issues to be Solved by Present Embodiment

As described above, for the purpose of the connection setup processing, the terminal apparatus 101 needs to establish a connection with the communication apparatus 151 operating in the connection setup mode. However, if the radio wave strength of wireless communication between the communication apparatus 151 operating in the connection setup mode and the terminal apparatus 101 is weak, the connection established between the communication apparatus 151 and the terminal apparatus 101 may be easily disconnected afterward. There has thus been an issue that the connection setup processing is interrupted partway and unable to be continued (first issue). To solve such an issue, in the present embodiment, processing for preventing the connection established between the communication apparatus 151 operating in the connection setup mode and the terminal apparatus 101 from being disconnected is performed. Specifically, the first application, after the connection is established, acquires a received signal strength indicator (RSSI) value that is a value related to the radio wave strength of the wireless communication between the communication apparatus 151 and the terminal apparatus 101. The first application then instructs the OS to convert the RSSI value into a signal level value, and thereby acquires the signal level value from the OS. The signal level in this processing refers to a value related to the radio wave strength of the wireless communication between the communication apparatus 151 and the terminal apparatus 101. The signal level in this processing is a value indicated based on the OS converting the received RSSI value, using an application program interface (API) based on program code “calculateSignalLevel” called by the first application. In the present embodiment, the signal level related to the radio wave strength of the wireless communication between the communication apparatus 151 and the terminal apparatus 101 will be referred to as first radio wave strength. Based on the first radio wave strength being determined to be less than a first threshold, the first application displays a notification screen corresponding to a state in which the first radio wave strength is less than the first threshold. More specifically, the first application displays, on this notification screen, text indicating that the first radio wave strength is weak and text for prompting the user to bring the communication apparatus 151 and the terminal apparatus 101 close to each other. The first threshold is a value based on 50% of the maximum value of the first radio wave strength. Details of the first radio wave strength will be described below.

To connect the communication apparatus 151 to the AP by the connection setup processing, the terminal apparatus 101 receives a list of APs to which the communication apparatus 151 can connect, from the communication apparatus 151. The terminal apparatus 101 may be configured to have the user select the AP to connect the communication apparatus 151 to from the APs listed, and notify the communication apparatus 151 of the AP selected by the user. However, in such a configuration, the user may erroneously select an AP of low radio wave strength from the AP list. There has thus been an issue that the connection between the communication apparatus 151 and the AP selected from the AP list may be easily disconnected, resulting in a failure of establishment of the connection (second issue). To solve such an issue, in the present embodiment, processing for preventing the connection between the communication apparatus 151 and the AP selected from the AP list from being disconnected is performed. Specifically, the first application acquires a signal level from the communication apparatus 151. The signal level in this processing refers to a value related to the radio wave strength of wireless communication between the communication apparatus 151 and the AP selected from the AP list. In the present embodiment, the signal level related to the radio wave strength of the wireless communication between the communication apparatus 151 and the selected AP will be referred to as a second radio wave strength. Based on the second radio wave strength being determined to be less than a second threshold, the first application displays a notification screen corresponding to a state in which the second radio wave strength is less than the second threshold. More specifically, the first application displays, on the notification screen, text indicating that the second radio wave strength is weak and text for prompting the user to bring the communication apparatus 151 and the selected AP close to each other.

To connect the communication apparatus 151 to the AP by the connection setup processing, the terminal apparatus 101 transmits a password to be used for connection to the AP to the communication apparatus 151. The communication apparatus 151 then connects to the AP using the received password. The password that the terminal apparatus 101 transmits to the communication apparatus 151 in this processing may be one input to the terminal apparatus 101 by the user. In such a case, the user needs to recognize the correct password and input the correct password to the terminal apparatus 101. In a conventional configuration, for the user to recognize the correct password and input the correct password to the terminal apparatus 101, the first application displays a screen for presenting a method for checking the correct password on a screen displayed by a specific application of the terminal apparatus 101. The specific application is an application that is different from the predetermined application and is pre-installed on the terminal apparatus 101 without being installed on the terminal apparatus 101 using the store application. The specific application is a setting application for configuring various settings of the terminal apparatus 101 and can configure various settings including Wi-Fi connection-related settings of the terminal apparatus 101. A screen for configuring the Wi-Fi connection-related settings of the terminal apparatus among various settings configurable by a second application will hereinafter be referred to as a Wi-Fi setup screen. The specific application will hereinafter be referred to as a second application. The second application can display a list of APs existing near the terminal apparatus 101 on the Wi-Fi setup screen. IIn a case where connection to an AP selected from the list needs a password, the second application can accept password input from the user on the Wi-Fi setup screen. IIn a case where the connection using the password is successful, the second application stores and manages various types of information about the AP to which the terminal apparatus 101 is connected using the password. Specific examples of the various types of information include the password, an SSID, and security-related information. In other words, the second application has a management function of storing and managing information about the AP to which the terminal apparatus 101 is currently connected, and information about APs to which the terminal apparatus 101 has connected in the past. With the management function, the second application can display on the Wi-Fi setup screen the password of the AP to which the terminal apparatus 101 is currently connected and the passwords of the APs to which the terminal apparatus 101 has connected in the past. The user can check the correct password of the AP by viewing the passwords displayed by the second application. To display the passwords using the foregoing second application, several operations are needed on a screen displayed by the second application. In a conventional configuration, a screen presenting the operations for displaying the passwords using the second application is thus displayed. However, in the conventional configuration, there have been cases where only AP passwords stored in the terminal apparatus 101 can be displayed on the Wi-Fi setup screen, or depending on the model of the terminal apparatus 101, no AP passwords can be viewed on the Wi-Fi setup screen. When the AP passwords are unable to be viewed on the Wi-Fi setup screen, there has thus been an issue that a different method (other connection method) than the first application transmitting the setting information to the communication apparatus 151 needs to be attempted (third issue). To solve such an issue, in the present embodiment, the terminal apparatus 101 displays a screen presenting a method for checking a password by other than the method of checking the password on the Wi-Fi setup screen. Specifically, the terminal apparatus 101 displays a screen presenting a method for checking the Wi-Fi router (AP) or the manual of the Wi-Fi router for the password.

The present disclosure does not necessarily solve all the foregoing issues, and may solve some of the foregoing issues. In other words, the present disclosure does not need to perform all the processes for solving the foregoing issues, and may perform some of the processes for solving the foregoing issues.

Specifically, with a configuration where the notification screen corresponding to the state in which the first radio wave strength is less than the first threshold is displayed to solve the first issue, the notification screen corresponding to the state in which the second radio wave strength is less than the second threshold does not need to be displayed to solve the second issue. Moreover, in the foregoing configuration for solving the first issue, the screen presenting the method for checking the Wi-Fi router or the manual of the Wi-Fi router for the AP password does not need to be displayed to solve the third issue. With a configuration where the notification screen corresponding to the state in which the second radio wave strength is less than the second threshold is displayed to solve the second issue, the notification screen corresponding to the state in which the first radio wave strength is less than the first threshold does not need to be displayed to solve the first issue. Moreover, in the foregoing configuration for solving the second issue, the screen presenting the method for checking the Wi-Fi router or the manual of the Wi-Fi router for the AP password does not need to be displayed to solve the third issue. With a configuration where the screen presenting the method for checking the Wi-Fi router or the manual of the Wi-Fi router for the AP password is displayed to solve the third issue, the notification screen corresponding to the state in which the first radio wave strength is less than the first threshold does not need to be displayed to solve the first issue. Moreover, with the foregoing configuration for solving the third issue, the notification screen corresponding to the state in which the second radio wave strength is less than the second threshold does not need to be displayed to solve the second issue.

### Processing That First Application Performs in Present Embodiment

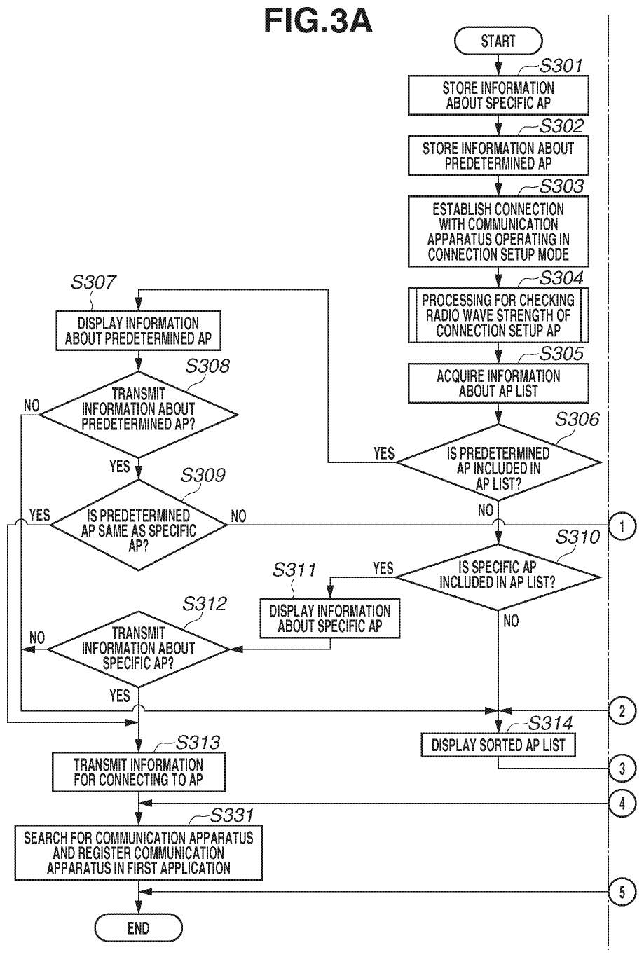

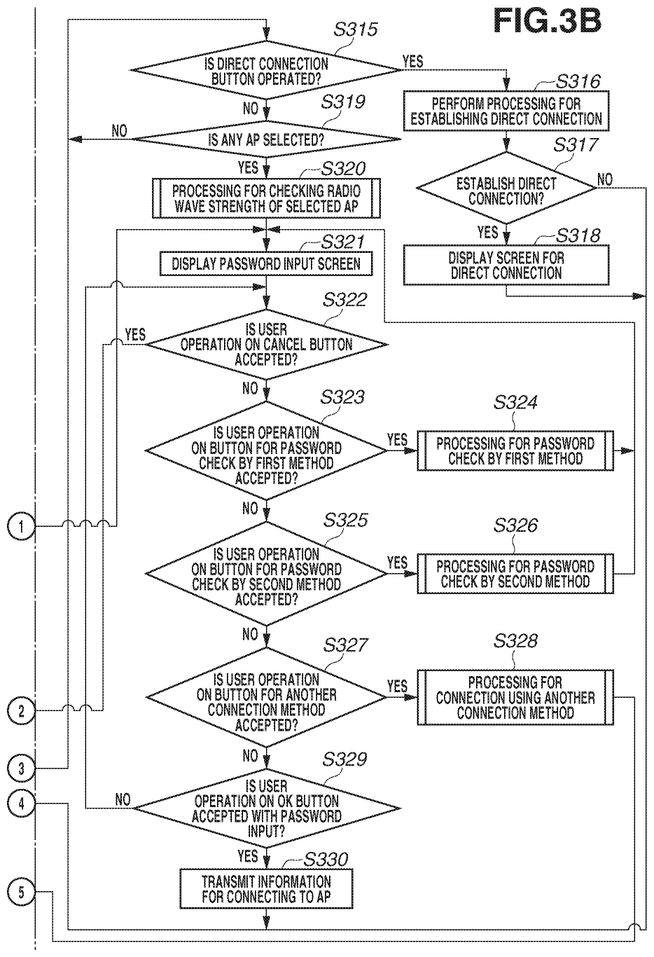

FIGS. 3A and 3B are flowcharts illustrating an example of processing that the terminal apparatus 101 performs using the first application in the present embodiment. The processes of the flowcharts of FIGS. 3A and 3B are implemented, for example, by the CPU 103 loading the first application stored in a memory such as the ROM 104 into the RAM 105 and executing the first application. The flowcharts of FIGS. 3A and 3B is started based on an operation for executing the connection setup processing being performed on a screen displayed by the first application. The flowcharts of FIGS. 3A and 3B may be started in response to launching of the first application.

In step S301, the first application acquires information about the AP to which the selected communication apparatus 151 is currently connected via Wi-Fi from a storage area managed by the first application. When the first application registers with itself the communication apparatus 151 in which infrastructure information is set, the first application performs processing for connectivity check with the communication apparatus 151 in which the infrastructure information is set. When performing the connectivity check, the first application acquires from the communication apparatus 151 the information about the AP to which the communication apparatus 151 is currently connected via Wi-Fi, and stores the information into the storage area managed by the first application. The AP to which the selected communication apparatus 151 is currently connected via Wi-Fi will hereinafter be referred to as a specific AP. The information about the specific AP to be acquired here includes the SSID and password. The information about the specific AP is acquired, for example, via an infrastructure connection or direct connection between the terminal apparatus 101 and the communication apparatus 151. When the terminal apparatus 101 is currently unable to communicate with the selected communication apparatus 151 or when the selected communication apparatus 151 is not currently connected to any AP via Wi-Fi, the information about the specific AP is not acquired. The timing when the information about the specific AP is acquired is not limited thereto. For example, the information about the specific AP may be acquired at timing before the start of the flowcharts of FIGS. 3A and 3B, based on the launching of the first application. In such a configuration, the processing of step S301 is skipped.

In step S302, the first application acquires from the OS information about the AP to which the terminal apparatus 101 is currently connected via Wi-Fi, and stores the information. The AP to which the terminal apparatus 101 is currently connected via Wi-Fi is, in other words, the AP to which the terminal apparatus 101 is connected when the processing triggering the start of the flowcharts of FIGS. 3A and 3B is performed. Examples of the processing triggering the start of the flowcharts of FIGS. 3A and 3B include the acceptance of the operation for performing the connection setup processing and the launching of the first application. The AP to which the terminal apparatus 101 is connected via Wi-Fi at the timing of step S301 will hereinafter be referred to as a predetermined AP. The information about the AP to be acquired here is information that the first application can acquire from the OS among various types of information about the AP. A specific example is the SSID. In a case where the terminal apparatus 101 is not currently connected to any AP via Wi-Fi, the information about the predetermined AP is not acquired.

In step S303, the first application performs processing for establishing a connection between the communication apparatus 151 operating in the connection setup mode and the terminal apparatus 101. Specifically, the first application instructs the OS to establish a connection between the communication apparatus 151 operating in the connection setup mode and the terminal apparatus 101. More specifically, the first application sets at least a part of the character string of the SSID of the communication apparatus 151 operating in the connection setup mode as an argument. The first application then executes a predetermined API for establishing a connection of the terminal apparatus 101, with the at least part of the character string of the SSID of the communication apparatus 151 set as the argument. The OS then searches for an apparatus having an SSID including the character string, and establishes a connection between the discovered apparatus (i.e., communication apparatus 151 operating in the connection setup mode) and the terminal apparatus 101. The communication apparatus 151 to which the terminal apparatus 101 is connected by this processing is the communication apparatus 151 that is first discovered by the search performed in the processing of step S303.

However, such a configuration is not restrictive. The first application may display a plurality of communication apparatuses 151 discovered by the search performed in the processing of step S303, and accept the user selection of one communication apparatus 151 from the plurality of communication apparatuses 151 displayed. The communication apparatus 151 to which the terminal apparatus 101 is connected by this processing then may be the communication apparatus 151 selected by the user. While the connection between the communication apparatus 151 operating in the connection setup mode and the terminal apparatus 101 is established, communication between the communication apparatus 151 and the terminal apparatus 101 is performed via the connection.

In the present embodiment, the first application, designed for iOS (registered trademark) or iPadOS (registered trademark), performs control so that the connection between the communication apparatus 151 operating in the connection setup mode and the terminal apparatus 101 is established as a second type of connection. Specifically, in step S303, the first application for iOS or iPadOS executes the predetermined API with a flag set to instruct the OS to establish a second type of connection. As a result, the OS establishes the connection between the communication apparatus 151 operating in the connection setup mode and the terminal apparatus 101 as a second type of connection. This prevents the connection between the communication apparatus 151 operating in the connection setup mode and the terminal apparatus 101 from being disconnected even when a predetermined time elapses after the first application starts operating in the background. When the OS of the terminal apparatus 101 is Android OS (registered trademark), all connections of the terminal apparatus 101 established by instructions from the first application are second type of connections. Thus, in a case where the first application is an application for Android OS, the flag for instructing the OS to establish a second type of connection therefore does not need to be set.

In step S304, the first application performs processing for checking the radio wave strength of the connection setup AP. The connection setup AP refers to the AP enabled by the communication apparatus 151 operating in the connection setup mode. Details of the processing of step S304 will be described below.

In step S305, the first application acquires information about a list of APs discovered by the search performed by the communication apparatus 151 from the communication apparatus 151. The APs discovered by the search performed by the communication apparatus 151 are ones to which the communication apparatus 151 can connect. APs to which the communication apparatus 151 can connect are ones located within the communication coverage of the communication apparatus 151 and compatible with the capabilities of the communication apparatus 151. For example, in a case where the communication apparatus 151 is capable of performing 2.4-GHz communication and not 5-GHz communication, the AP list indicated by the acquired information includes APs that support 2.4-GHz communication and not ones that support 5-GHz communication. In this processing, the information acquired by the first application includes the SSID and radio wave strength of each AP discovered by the search performed by the communication apparatus 151. The radio wave strength of each AP discovered by the search performed by the communication apparatus 151 refers to the radio wave strength of wireless communication between the AP discovered by the search performed by the communication apparatus 151 and the communication apparatus 151. The value of the radio wave strength acquired from the communication apparatus 151 in this processing is a second radio wave strength value, which is an integer value in the range of 0 to 100. The second radio wave strength value is a value indicated based on the RSSI value received by the communication apparatus 151 being converted by the communication apparatus 151. The first application stores the information acquired in this processing into a storage area that the first application can refer to.

In step S306, the first application determines whether the AP specified by the information stored in step S302 (predetermined AP) is included in the AP list indicated by the information acquired in step S305. In a case where the first application determines that the determination result is yes (YES in step S306), the processing proceeds to step S307. In a case where the first application determines that the determination result is no (NO in step S306), the processing proceeds to step S310.

In step S307, the first application displays a confirmation screen that displays information about the predetermined AP and prompts the user to confirm whether to set the predetermined AP as a connection target of the communication apparatus 151. The information displayed here is the information stored in step S302, for example, the SSID of the predetermined AP.

In step S308, the first application determines whether to transmit the information about the predetermined AP to the communication apparatus 151. In other words, this determination is about whether the user has confirmed to set the predetermined AP as the connection target of the communication apparatus 151. In a case where an input indicating that the predetermined AP is to be set as the connection target of the communication apparatus 151 is performed on the foregoing confirmation screen, the determination result is thus yes, and the predetermined AP is identified as the connection target of the communication apparatus 151. In a case where an input indicating that the predetermined AP is not to be set as the connection target of the communication apparatus 151 is performed on the confirmation screen, the determination result is no. In a case where the first application determines that the determination result is yes (YES in step S308), the processing proceeds to step S309. In a case where the first application determines that the determination result is no (NO in step S308), the processing proceeds to step S314.

In step S309, the first application determines whether the predetermined AP is the same as the specific AP. In a case where the predetermined AP is the same as the specific AP, the first application retains the password of the predetermined AP. This determination is thus about whether the first application retains the password of the predetermined AP. In other words, this determination is about whether the password of the predetermined AP is stored in the storage area that the first application can refer to. In a case where the first application determines that the determination result is yes (YES in step S309), the processing proceeds to step S313 to transmit the information about the predetermined AP to the communication apparatus 151. In a case where the first application determines that the determination result is no (NO in step S309), the processing proceeds to step S321 to display a password input screen.

In step S309, whether the predetermined AP is the same as the specific AP does not necessarily need to be determined. The determination in step S309 may be processing for determining whether the predetermined AP is an AP corresponding to the information stored in the storage area that the first application can refer to.

Examples of the case where the determination in such a configuration is yes include where the password for connecting to the predetermined AP has been input to the first application by the user and transmitted to the communication apparatus 151 in the connection setup processing performed by the first application in the past. Examples of the case where the determination in such a configuration is no include where no password for connecting to the predetermined AP has been input to the first application by the user in the connection setup processing performed by the first application in the past.

In step S310, which is performed when the determination result of step S306 is no, the first application determines whether the AP specified by the information stored in step S301 (specific AP) is included in the AP list indicated by the information acquired in step S305. In a case where the first application determines that the determination result is yes (YES in step S310), the processing proceeds to step S311. In a case where the first application determines that the determination result is no (NO in step S310), the processing proceeds to step S314.

In step S311, the first application displays a confirmation screen that displays information about the specific AP and prompts the user to confirm whether to set the specific AP as the connection target of the communication apparatus 151. The information displayed here is the information stored in step S301, for example, the SSID of the specific AP.

In step S312, the first application determines whether to transmit the information about the specific AP to the communication apparatus 151. In other words, this determination is about whether the user has confirmed to set the specific AP as the connection target of the communication apparatus 151. In a case where an input indicating that the specific AP is to be set as the connection target of the communication apparatus 151 is performed on the foregoing confirmation screen, the determination result is thus yes, and the specific AP is identified as the connection target of the communication apparatus 151. In a case where an input indicating that the specific AP is not to be set as the connection target of the communication apparatus 151 is performed on the confirmation screen, the determination result is no. In a case where the first application determines that the determination result is yes (YES in step S312), the processing proceeds to step S313. In a case where the first application determines that the determination result is no (NO in step S312), the processing proceeds to step S314.

In step S313, the first application transmits information for connecting to the AP identified as the connection target of the communication apparatus 151 to the communication apparatus 151. The information transmitted here includes the SSID of the AP identified as the connection target of the communication apparatus 151 and the password for connecting to the AP identified as the connection target of the communication apparatus 151. In this processing, the AP identified as the connection target of the communication apparatus 151 is either the predetermined AP that is the same as the specific AP or the specific AP. That is, the password transmitted here is a password of the specific AP, the one acquired from the communication apparatus 151 in step S301. In other words, the password transmitted here is the password retained by the first application (password stored in the storage area that the first application can refer to). The first application thus transmits the password to the communication apparatus 151 after the identification of the connection target of the communication apparatus 151, without accepting password input from the user. After the information for connecting to the AP identified as the connection target of the communication apparatus 151 is transmitted to the communication apparatus 151, the communication apparatus 151 terminates the connection setup mode and connects to the AP identified as the connection target of the communication apparatus 151, using the received information. With the connection setup mode terminated, the connection between the communication apparatus 151 and the terminal apparatus 101 is also disconnected. The terminal apparatus 101 reconnects to the predetermined AP that is the AP to which the terminal apparatus 101 has been connected before the connection to the communication apparatus 151, using the OS's reconnection function. The processing then proceeds to step S331. The configuration is not limited to proceeding to step S331. The processing may be configured to proceed to processing where a screen is displayed to search the Wi-Fi network, to which the terminal apparatus 101 is connected, for the communication apparatus 151, like step S710 to be described below.

In a case where the determination result of step S308 is no (NO in step S308), in a case where the determination result of step S310 is no (NO in step S310), or in a case where the determination result of step S312 is no (NO in step S312), the processing proceeds to step S314.

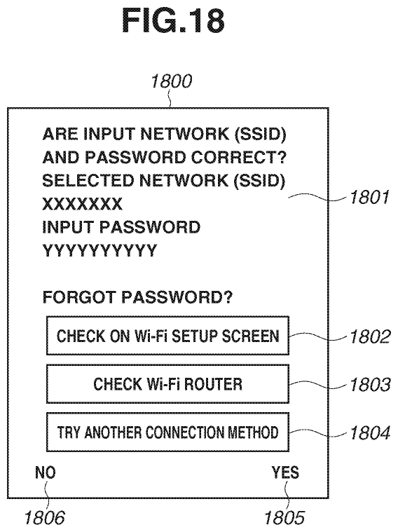

In a case where the communication apparatus 151 is not discovered by the foregoing search, a screen for checking a password using a second method may be displayed to prompt the user to check the password of the AP again. Specifically, the first application displays a screen 1800 illustrated in FIG. 18 based on the communication apparatus 151 not being discovered by the search. The screen 1800 includes an area 1801 for displaying the SSID of the AP selected from the AP list and the AP's password input by the user. The screen 1800 also includes a button 1802 for password check by a first method, a button 1803 for password check by the second method, a button 1804 for another connection method, a YES button 1805, and a NO button 1806. The first application displays a screen 1100 based on the button 1803 being operated, and thereby prompts the user to check the password using the second method. In the case of accepting the input of a password for connecting to the AP identified as the connection target of the communication apparatus 151 from the user and transmitting the password to the communication apparatus 151, the first application displays the screen 1800. The first application then displays the screen 1100 based on the button 1803 being operated by the user. When transmitting the password to the communication apparatus 151 without accepting password input from the user based on the password having been stored, the first application may perform control to not display the screens 1800 and 1100.

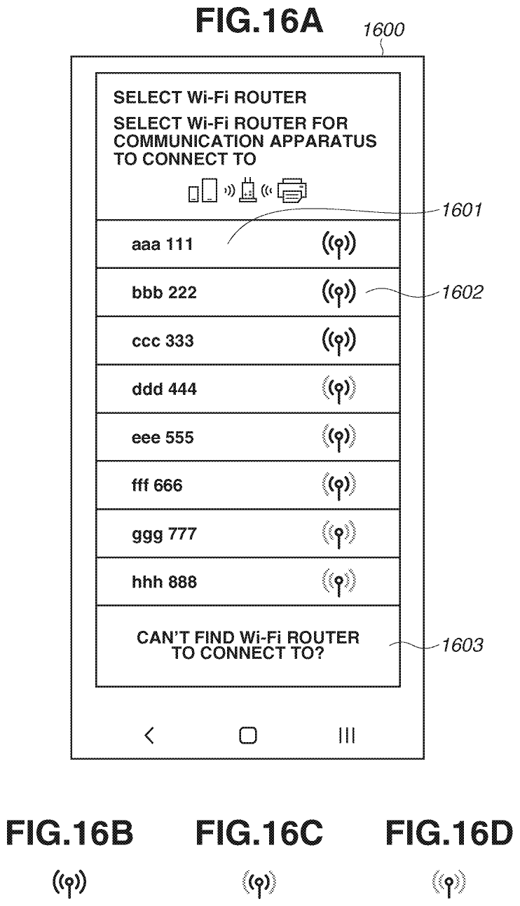

In step S314, the first application displays the AP list indicated by the information acquired in step S305. In this processing, the first application sorts the APs in descending order of the radio wave strength, using the signal level values corresponding to the respective APs acquired in step S305. FIG. 16A illustrates an example of the screen displayed in this processing. A screen 1600 (list screen) includes an area 1601 where the APs are listed, an area 1602 where the magnitudes of the radio wave strengths of the APs are displayed, and a button 1603 for guiding to another connection method or direct connection. The area 1601 displays APs with higher radio wave strengths above and APs with lower radio wave strengths below. In other words, the AP displayed at the top of the list in the area 1601 is the AP having the highest radio wave strength among the APs listed. The AP listed at the bottom of the list in the area 1601 is the AP having the lowest radio wave strength among the APs listed. The area 1602 includes icons for indicating the magnitudes of the radio wave strengths of the respective APs listed. FIGS. 16B, 16C, and 16D illustrate details of the icons for indicating the magnitudes of the radio wave strengths of the APs listed. FIG. 16B illustrates an icon indicating that the radio wave strength acquired in step S305 corresponds to 81% to 100%, with the maximum value of the radio wave strength to be acquired in step S305 as 100. The icon of FIG. 16B is displayed next to the SSIDs of APs of which the radio wave strength value acquired in step S305 is an integer value in the range of 81 to 100. FIG. 16C illustrates an icon indicating that the radio wave strength acquired in step S305 corresponds to 50% to 80%, with the maximum value of the radio wave strength to be acquired in step S305 as 100. The icon of FIG. 16C is displayed next to the SSIDs of APs of which the radio wave strength value acquired in step S305 is an integer value in the range of 50 to 80. FIG. 16D illustrates an icon indicating that the radio wave strength acquired in step S305 corresponds to 0% to 49%, with the maximum value of the radio wave strength to be acquired in step S305 as 100. The icon of FIG. 16D is displayed next to the SSIDs of APs of which the radio wave strength value acquired in step S305 is an integer value in the range of 0 to 49. That the minimum value of the signal level value to be acquired from the communication apparatus 151 is 0 and the maximum value is 100 is known to the first application. The first application can thus calculate what proportion the radio wave strength of each AP acquired in step S305 is relative to 100, which is the maximum value of the radio wave strength to be acquired in step S305. In a case where the AP that the user desires as the connection target of the communication apparatus 151 is not included in the list, the user operates the button 1603.

In step S315, the first application determines whether the button (direct connection button) 1603 is operated. In a case where the first application determines that the determination result is yes (YES in step S315), the processing proceeds to step S316. In a case where the first application determines that the determination result is no (NO in step S315), the processing proceeds to step S319.

In step S316, the first application performs processing for establishing a direct connection between the communication apparatus 151 and the terminal apparatus 101. Specifically, the first application initially transmits direct setting information to the communication apparatus 151. The first application then acquires connection information for establishing a direct connection with the communication apparatus 151 from the communication apparatus 151. The first application then instructs the OS to establish a connection between the communication apparatus 151 operating in the direct connection mode and the terminal apparatus 101. More specifically, the first application identifies the SSID of the communication apparatus 151 operating in the direct connection mode from the received connection information. The first application then executes a predetermined API for establishing a connection of the terminal apparatus 101, with at least a part of the character string of the identified SSID as an argument. The OS searches for an apparatus having an SSID including the character string, and displays a confirmation screen for confirming whether to establish a direct connection between the discovered apparatus (communication apparatus 151 operating in the direct connection mode) and the terminal apparatus 101. If the first application is an application for iOS, the first application in this processing may execute the predetermined API with the flag set to instruct the OS to establish a connection that will not be disconnected even when the first application transitions to the background. In other words, the direct connection between the communication apparatus 151 and the terminal apparatus 101 may be established as a second type of connection. However, such a configuration is not restrictive. In this processing, the first application may execute the predetermined API without setting the flag, in which case the direct connection between the communication apparatus 151 and the terminal apparatus 101 is established as a first type of connection.

In step S317, the first application determines whether a user operation indicating establishment of a direct connection is performed on the confirmation screen displayed by the OS in step S316. This determination is performed by the first application receiving a notification from the OS that indicates which operation is performed on the confirmation screen displayed by the OS. In a case where the user operation indicating establishment of a direct connection is performed, the OS establishes the direct connection. In a case where a user operation indicating no establishment of a direct connection is performed, the OS does not establish a direct connection. In a case where the first application determines that the determination result is yes (YES in step S317), the processing proceeds to step S318. In a case where the first application determines that the determination result is no (NO in step S317), the processing proceeds to step S331.

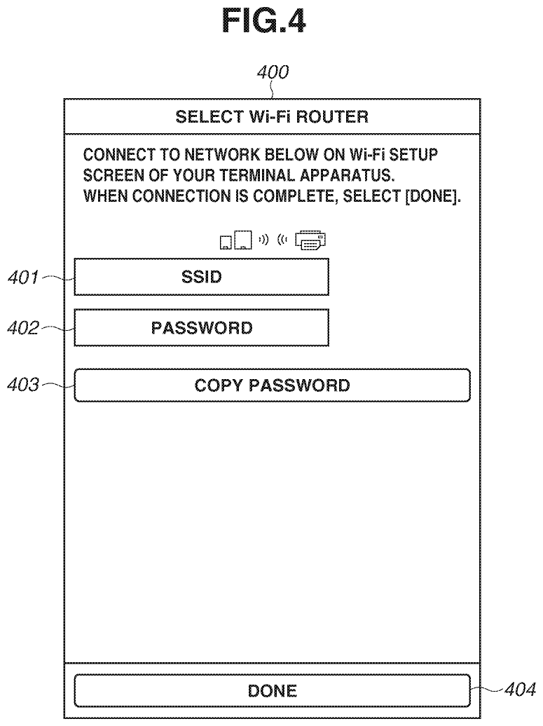

In step S318, the first application displays a screen for direct connection. FIG. 4 illustrates an example of the screen displayed in this processing. A screen 400 includes an SSID display area 401, a password display area 402, an area 403 for copying a password, and a completion button 404. The SSID display area 401 is an area displaying the SSID of the communication apparatus 151 operating in the direct connection mode. The password display area 402 is an area displaying the password of the communication apparatus 151 operating in the direct connection mode. When the area 403 is operated, the first application copies the password of the communication apparatus 151 operating in the direct connection mode and saves the password in the clipboard of the terminal apparatus 101. Copying the password of the communication apparatus 151 operating in the direct connection mode enables the user to easily input the password to the second application and establish the direct connection using the second application. The screen 400 may include a message for prompting the user to establish a direct connection via the Wi-Fi setup screen displayed by the second application and/or a message for prompting the user to operate the completion button 404 when the establishment of the direct connection is complete. In a case where the completion button 404 is operated, the processing proceeds to step S331. The configuration is not limited to proceeding to step S331. The processing may be configured to proceed to processing where a screen is displayed to search the Wi-Fi network, to which the terminal apparatus 101 is connected, for the communication apparatus 151, like step S710 to be described below.

In step S319, which is performed when the determination result of step S315 is no, the first application determines whether any AP is selected by the user from the displayed AP list. In a case where the first application determines that the determination result is yes (YES in step S319), the first application identifies the selected AP as the connection target of the communication apparatus 151 and the processing proceeds to step S320. In a case where the first application determines that the determination result is no (NO in step S319), the processing returns to step S315 and the first application waits to accept any of the operations. Details of the processing of step S320 will be described below.

In step S321, the first application displays a password input screen for accepting the input of a password for connecting to the AP identified as the connection target of the communication apparatus 151.

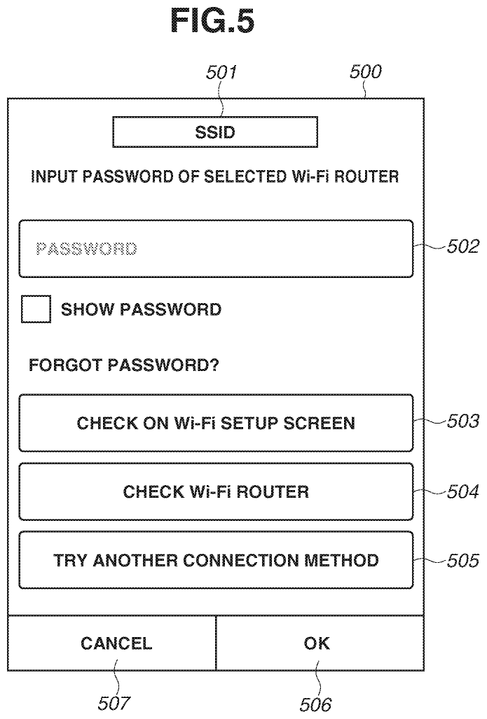

The password input screen may be displayed as a pop-up over the AP list. FIG. 5 illustrates an example of the screen displayed in this processing. A password input screen 500 includes an SSID display area 501, a password input box 502, and a button 503 for password check by the first method. The password input screen 500 also includes a button 504 for password check by the second method, a button 505 for another connection method, an OK button 506, and a cancel button 507. The SSID display area 501 is an area displaying the SSID of the AP identified as the connection target of the communication apparatus 151.

The password input box 502 is an area for accepting input of the password of the AP identified as the connection target of the communication apparatus 151 from the user. The button 503 for password check by the first method is a button for checking a password using the first method. The first method refers to the method for checking the AP password on the Wi-Fi setup screen displayed by the second application. The button 504 for password check by the second method is a button for checking a password using the second method. The second method refers to the method for checking the AP password by referring to the Wi-Fi router or the manual of the Wi-Fi router. The button 505 for another connection method is a button for displaying a manual about another connection method. In the present embodiment, another connection method refers to a connection method other than that in which a connection between the communication apparatus 151 and another apparatus is established by the first application transmitting setting information to the communication apparatus 151. In other words, another connection method refers to a method for establishing a connection between the communication apparatus 151 and another apparatus without the first application transmitting setting information to the communication apparatus 151. As described above, the first application accepts the input of the password of the AP from the user on the password input screen 500. However, when the user does not know the password, the user is unable to input the password to the password input screen 500. In view of this, in the present embodiment, the password input screen 500 displays the buttons 503, 504, and 505.

Depending on the OS version of the terminal apparatus 101, the second application may be unable to display the password of the AP to which the terminal apparatus 101 is currently connected or the passwords of APs to which the terminal apparatus 101 has connected in the past on the Wi-Fi setup screen. For example, in a case where the OS of the terminal apparatus 101 is one earlier than the version to be described below, the second application is unable to display the password on the Wi-Fi setup screen. Specifically, for example, in a case where the OS of the terminal apparatus 101 is a version earlier than Android 10, earlier than iOS 16, or earlier than iPadOS 16, the second application is unable to display the password on the Wi-Fi setup screen. In step S321, the first application may therefore identify the version of the OS of the terminal apparatus 101 and determine whether the identified version is one with which the second application is unable to display the password on the Wi-Fi setup screen. In a case where the first application determines that the determination result is yes, the first application displays a password input screen without the button 503 for password check.

In a case where the first application determines that the determination result is no, the first application may display a password input screen including the button 503 for password check. The password input screen without the button 503 for password check shall include the other buttons and areas of the password input screen 500. In other words, the button 504 for password check by the second method and the button 505 for another connection method are displayed regardless of the OS version. In a case where, for example, the first application only supports OS versions with which the second application can display the password on the Wi-Fi setup screen, the version check and the control to switch display screens based on the result of the version check do not need to be performed.

In step S322, the first application determines whether a user operation on the cancel button 507 is accepted. In a case where the first application determines that the determination result is yes (YES in step S322), the processing proceeds to step S314 to display the AP list. In a case where the first application determines that the determination result is no (NO in step S322), the processing proceeds to step S323.

In step S323, the first application determines whether a user operation on the button 503 for password check by the first method is accepted. In a case where the first application determines that the determination result is yes (YES in step S323), the processing proceeds to step S324. In a case where the first application determines that the determination result is no (NO in step S323), the processing proceeds to step S325. Details of the processing of step S324 will be described below.

In step S325, which is performed when the determination result of step S323 is no, the first application determines whether a user operation on the button 504 for password check by the second method is accepted. In a case where the first application determines that the determination result is yes (YES in step S325), the processing proceeds to step S326. In a case where the first application determines that the determination result is no (NO in step S325), the processing proceeds to step S327. Details of the processing of step S326 will be described below.

In step S327, which is performed when the determination result of step S325 is no, the first application determines whether a user operation on the button 505 for another connection method is accepted. In a case where the first application determines that the determination result is yes (YES in step S327), the processing proceeds to step S328. In a case where the first application determines that the determination result is no (NO in step S327), the processing proceeds to step S329. Details of the processing of step S328 will be described below.

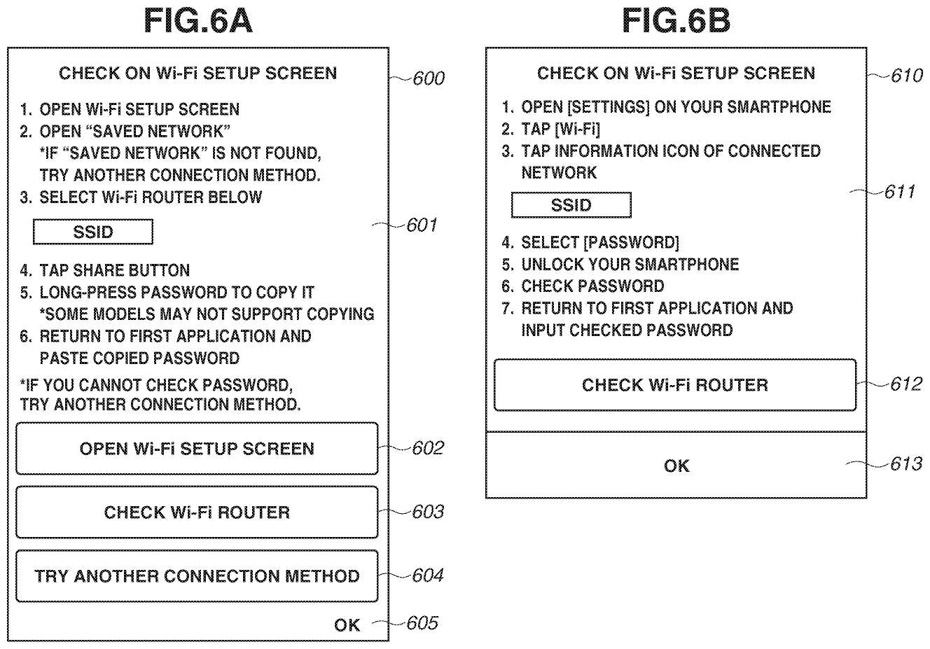

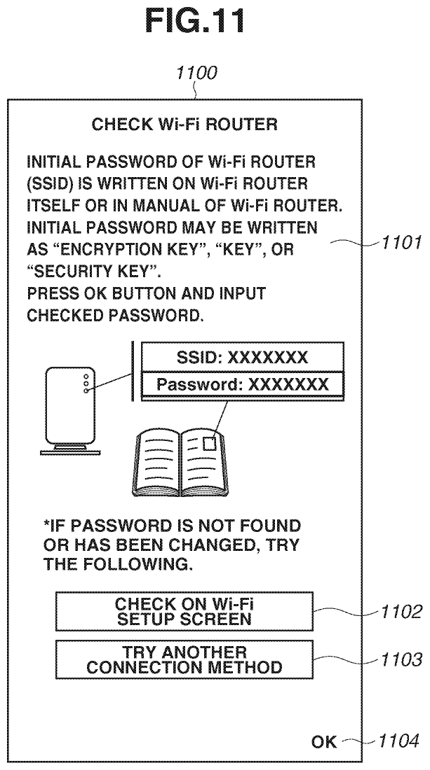

In step S329, the first application determines whether a user operation on the OK button 506 is accepted with a password input to the password input box 502. The user, based on operating the button 503 for password check by the first method, checks the password on the Wi-Fi setup screen by following the text displayed on the screen illustrated in FIG. 6A or 6B. Alternatively, the user, based on operating the button 504 for password check by the second method, checks the Wi-Fi router or the manual of the Wi-Fi router for the password by following the text displayed on a screen illustrated in FIG. 11 to be described below. Having checked the password, the user can then input the password into the password input box 502. In a case where the user has copied the password on the Wi-Fi setup screen and saved the password to the clipboard, the user can input the password by pasting the saved password into the password input box 502. In a case where the first application determines that the determination result is yes (YES in step S329), the processing proceeds to step S330. In a case where the first application determines that the determination result is no (NO in step S329), the processing returns to step S322 and the first application waits to accept any of the operations from the user on the password input screen 500.

In step S330, the first application transmits information for connecting to the AP identified as the connection target of the communication apparatus 151 to the communication apparatus 151. Specifically, the information transmitted here includes the password input to the password input box 502 and the SSID of the AP identified as the connection target of the communication apparatus 151. After the information for connecting to the AP identified as the connection target of the communication apparatus 151 is transmitted to the communication apparatus 151, the communication apparatus 151 terminates the connection setup mode and connects to the AP identified as the connection target of the communication apparatus 151, using the received information. With the connection setup mode terminated, the connection between the communication apparatus 151 and the communication apparatus 151 is also disconnected. The terminal apparatus 101 reconnects to the predetermined AP that is the AP to which the terminal apparatus 101 has been connected before the connection to the communication apparatus 151, using the OS's reconnection function. The processing then proceeds to step S331.

In step S331, the first application searches the Wi-Fi network to which the terminal apparatus 101 is connected for the communication apparatus 151. For example, in a case where the AP identified as the connection target of the communication apparatus 151 is the predetermined AP, the communication apparatus 151 is discovered by this search since the communication apparatus 151 and the terminal apparatus 101 are both connected to the predetermined AP. Examples of the case where the communication apparatus 151 is not discovered by this search include the following. A first example is where the AP identified as the connection target of the communication apparatus 151 is an AP other than the predetermined AP, and the communication apparatus 151 is connected to the AP other than the predetermined AP. A second example is where the input password is incorrect and the communication apparatus 151 fails to connect to the AP. In a case where the communication apparatus 151 is discovered by this search, the first application acquires information about the communication apparatus 151 from the communication apparatus 151 via the Wi-Fi network to which the terminal apparatus 101 is connected, and registers the communication apparatus 151 with itself. Here, the first application may automatically set the newly registered communication apparatus 151 as the selected communication apparatus 151. The first application then ends processing and displays its home screen.

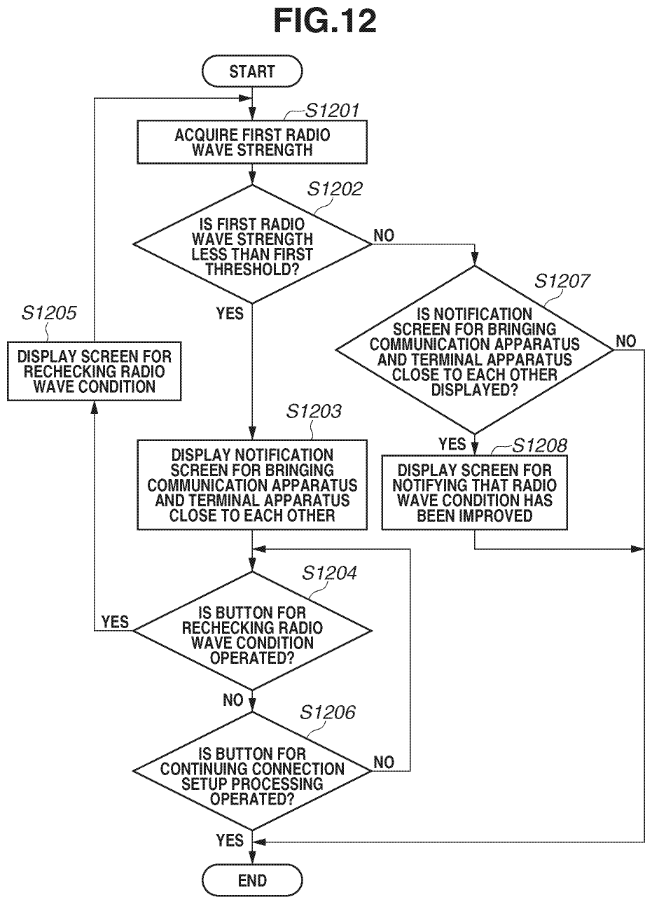

FIG. 12 is a flowchart illustrating an example of processing that the terminal apparatus 101 performs using the first application in the present embodiment. The processes of the flowchart of FIG. 12 are implemented, for example, by the CPU 103 loading the first application stored in the memory such as the ROM 104 into the RAM 105 and executing the first application. The processing of this flowchart corresponds to the processing of step S304.

In step S1201, the first application acquires the first radio wave strength, which is the strength of radio waves from the communication apparatus 151 operating in the connection setup mode and connected in step S303, using the first method. In the present embodiment, the first radio wave strength refers to the signal level that is a value related to the radio wave strength of wireless communication between the communication apparatus 151 to which the terminal apparatus 101 is connected at the timing of step S304 and the terminal apparatus 101. The first radio wave strength is a signal level value into which the strength of radio waves that the terminal apparatus 101 receives from the communication apparatus 151 is converted. The communication apparatus 151 connected at the timing of step S304 is equivalent to the communication apparatus 151 operating in the connection setup mode. Details of the processing for acquiring the first radio wave strength using the first method will now be described.

The first method is a method in which the first application calls a first API for acquiring information corresponding to the communication apparatus 151 to which the terminal apparatus 101 is connected at the timing of step S304. The first API is an API that the first application calls based on program code “getConnectionInfo”. By calling this API, the first application acquires information corresponding to the communication apparatus 151 from the OS. Examples of the information corresponding to the communication apparatus 151 include information about an RSSI value, SSID, password, and frequency band, for example. The RSSI is a value related to the radio wave strength and is in units of dBm. Acquiring the information corresponding to the communication apparatus 151 from the OS, the first application calls a second API for referring to the RSSI value included in the information. The second API is an API that the first application calls based on program code “getRssi”, and is different from the first API. This enables the first application to refer to the RSSI value included in the information corresponding to the communication apparatus 151, acquired from the OS. Referring to the RSSI value included in the information corresponding to the communication apparatus 151, the first application calls a third API or fourth API for instructing the OS to convert the RSSI value referred to by the first application into a signal level value. The third API will initially be described. The third API is an API that the first application can call based on the OS of the terminal apparatus 101 being Android OS 11 or later, and is an API based on the program code “calculateSignalLevel”. The third API is an API different from the first and second APIs. When the first application calls the third API, the OS converts the RSSI value referred to by the first application into a signal level value. The first application then acquires the signal level value from the OS. This signal level will hereinafter be referred to as a first radio wave strength. When the first application calls the third API, the first radio wave strength takes an integer value within a range from 0, which is a value indicating that the radio wave strength is weakest, to a predetermined value indicating that the radio wave strength is strongest. In other words, the minimum value of the first radio wave strength is 0, and the maximum value is the predetermined value. The predetermined value is an integer value greater than or equal to 0, set by the OS.

Next, the fourth API will be described. The fourth API is an API that the first application calls based on the OS of the terminal apparatus 101 being earlier than Android OS 11, and is an API based on the program code “calculateSignalLevel”. The fourth API is an API that the first application can call even in a case where the OS of the terminal apparatus 101 is Android OS 11 or later. The fourth API is an API different from the first, second, and third APIs. When the first application calls the fourth API, the OS converts the RSSI value referred to by the first application into a signal level value. The first application then acquires the signal level value from the OS. When the first application calls the fourth API, the first radio wave strength takes an integer value within a range from 0, which is a value indicating that the radio wave strength is weakest, to a specific value indicating that the radio wave strength is strongest. In other words, the minimum value of the first radio wave strength is 0, and the maximum value is the specific value. The specific value is an integer value greater than or equal to 0, freely set by the first application.

As described above, since the predetermined value that is the maximum value of the first radio wave strength when the first application calls the third API is an integer value set by the OS, the user is unable to freely change the maximum value of the first radio wave strength. By contrast, the specific value that is the maximum value of the first radio wave strength when the first application calls the fourth API is an integer value freely set by the first application, and the user can thus freely change the maximum value of the first radio wave strength. This is the main difference between the third API and the fourth API.

In the present embodiment, the first application controls whether to call the third API or the fourth API based on the determination result of the version of the Android OS. However, the present disclosure is not limited to such a configuration. Only the fourth API may be called regardless of the OS version, without determining the version of the Android OS.

In step S1202, the first application determines whether the first radio wave strength is less than a first threshold.

The first threshold is a value freely set by the first application, and is based on 50% of the foregoing predetermined value or specific value. In a case where the first application calls the third API in step S1201, the first application acquires the predetermined value from the OS at timing before the threshold determination is performed in this processing. In a case where the first application determines that the first radio wave strength is less than the first threshold (YES in step S1202), the processing proceeds to step S1203. In a case where the first application determines that the first radio wave strength is not less than the first threshold (NO in step S1202), the processing proceeds to step S1207.

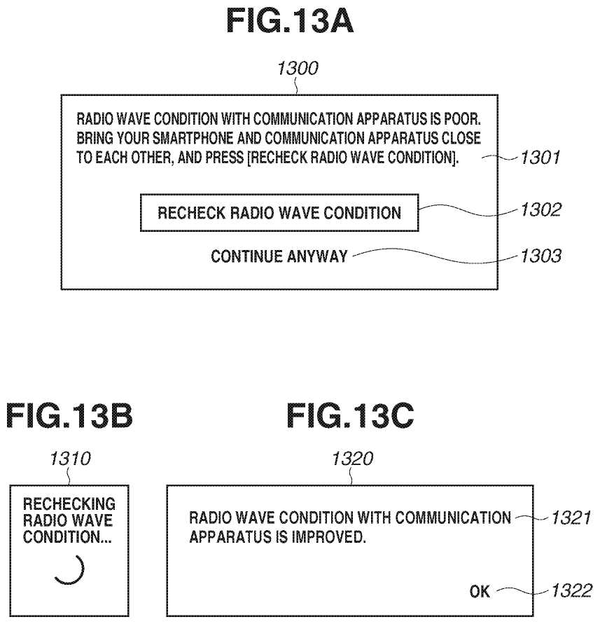

In step S1203, the first application displays a notification screen for notifying the user to bring the communication apparatus 151 and the terminal apparatus 101 close to each other. FIG. 13A illustrates an example of the notification screen displayed in this processing. A screen 1300 is a notification screen for notifying the user to bring the communication apparatus 151 and the terminal apparatus 101 close to each other. In other words, the screen 1300 is a notification screen for issuing a notification to the user so that the communication apparatus 151 and the terminal apparatus 101 approach each other. The screen 1300 includes an area 1301 displaying text for notifying the user to bring the communication apparatus 151 and the terminal apparatus 101 close to each other, a button 1302 for rechecking a radio wave condition, and a button 1303 for continuing the connection setup processing. The area 1301 displays text indicating that the first radio wave strength is weak and text for prompting the user to bring the communication apparatus 151 and the terminal apparatus 101 close to each other and recheck the radio wave condition. The radio wave condition in this processing corresponds to the radio wave condition of wireless communication between the communication apparatus 151 and the terminal apparatus 101. The button 1302 for rechecking the radio wave condition is a button to be operated by the user when the user wants to check the radio wave condition of the wireless communication between the communication apparatus 151 and the terminal apparatus 101 again. In other words, the button 1302 is an item for accepting an instruction to acquire the value related to the radio wave strength of the communication apparatus 151 that is the communication partner of the terminal apparatus 101 again. The button 1302 may hereinafter be referred to as a button 1302 for rechecking the radio wave condition of the wireless communication between the communication apparatus 151 and the terminal apparatus 101. The button 1302 may be referred to as a button for acquiring the radio wave strength of the communication apparatus 151 again. In the present embodiment, the radio wave condition is determined to be poor if the first radio wave strength acquired in step S1201 is less than the first threshold. In other words, the poor radio wave condition is equivalent to the first radio wave strength being weak.

In a case where the user wants to check the radio wave condition again, the user operates the button 1302 for rechecking the radio wave condition. In a case where the user wants to continue the connection setup processing without rechecking the radio wave condition, the user operates the button 1303 for continuing the connection setup processing.

In step S1204, the first application determines whether the button 1302 for rechecking the radio wave condition is operated. In a case where the first application determines that the determination result is yes (YES in step S1204), the processing proceeds to step S1205. In a case where the first application determines that the determination result is no (NO in step S1204), the processing proceeds to step S1206.

In step S1205, the first application displays a screen for rechecking the radio wave condition. FIG. 13B illustrates an example of the screen displayed in this processing. A screen 1310 includes text and an icon indicating that the radio wave condition is being checked again. After the display of the screen 1310, the processing returns to step S1201, and the first application performs the processing for acquiring the first radio wave strength again.

In step S1206, which is performed when the determination result of step S1204 is no, the first application determines whether the button 1303 for continuing the connection setup processing is operated. In a case where the first application determines that the determination result is yes (YES in step S1206), the processing of this flowchart ends. In a case where the first application determines that the determination result is no (NO in step S1206), the processing returns to step S1204 and the first application determines whether the button 1302 for rechecking the radio wave condition is operated.

In step S1207, which is performed when the determination result of step S1202 is no, the first application determines whether the notification screen for notifying the user to bring the communication apparatus 151 and the terminal apparatus 101 close to each other is displayed. This notification screen refers to the screen displayed by the first application in step S1203 in a case where the first application determines in step S1202 that the first radio wave strength is less than the first threshold. In a case where the first application determines that the determination result is yes (YES in step S1207), the processing proceeds to step S1208. In a case where the first application determines that the determination result is no (NO in step S1207), the processing of this flowchart ends.

In step S1208, the first application displays a screen for notifying the user that the radio wave condition has been improved. FIG. 13C illustrates an example of the screen displayed in this processing. A screen 1320 includes an area 1321 indicating that the radio wave condition has been improved, and an OK button 1322.

The area 1321 displays text indicating that the radio wave condition has been improved. In a case where the OK button 1322 is operated, the first application ends the processing of this flowchart.

The first application may continue the acquisition of the first radio wave strength while the communication apparatus 151 operating in the connection setup mode and the terminal apparatus 101 are connected. In such a case, the screen 1300 does not include the button 1302 for rechecking the radio wave condition, and displays the magnitude of the continuously acquired first radio wave strength using an icon. The icon may be updated each time the value of the first radio wave strength is acquired during display of the screen 1300. While the communication apparatus 151 operating in the connection setup mode and the terminal apparatus 101 are connected, the first application may display the screen 1320 each time the acquired radio wave strength reaches or exceeds the first threshold, and display the screen 1300 each time the radio wave strength falls below the first threshold. The first application may set thresholds for the radio wave strength stepwise, and display messages corresponding to the respective stages on the screen 1300.

In the present embodiment, the processing for checking the radio wave strength of the connection setup AP is performed at some point between when the OS performs the search for the communication apparatus 151 and when the password of the AP is input. The reason is that if the radio wave strength of the connection setup AP is weak, the connection between the terminal apparatus 101 and the communication apparatus 151 may be easily disconnected, resulting in an issue that the AP information is unable to be transmitted from the terminal apparatus 101 to the communication apparatus 151. When the first application checks the radio wave strength of the connection setup AP after the user inputs the password of the AP, the AP information may fail to be transmitted to the communication apparatus 151 due to low radio wave strength of the connection setup AP despite the user password input. In the present embodiment, to avoid such a situation, the processing for checking the radio wave strength of the connection setup AP is performed at the foregoing timing.

In the present embodiment, the first application acquires the first radio wave strength from the OS and determines whether the acquired first radio wave strength is less than the first threshold. However, such a configuration is not restrictive. For example, the first application may acquire the RSSI value received by the OS, and make a threshold determination using the RSSI value. The first application may employ a method of determining whether the first radio wave strength is greater than or equal to the first threshold.

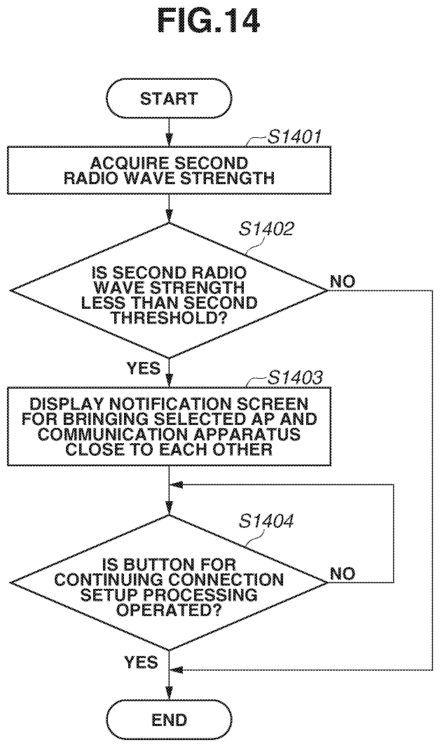

FIG. 14 is a flowchart illustrating an example of processing that the terminal apparatus 101 performs using the first application in the present embodiment. The processes of the flowchart of FIG. 14 are implemented, for example, by the CPU 103 loading the first application stored in the memory such as the ROM 104 into the RAM 105 and executing the first application. The processing of this flowchart corresponds to the processing of step S320.

In step S1401, the first application acquires a second radio wave strength. The second radio wave strength refers to the radio wave strength of wireless communication between the AP selected from the AP list displayed in step S314 and the communication apparatus 151, and corresponds to a signal level. The second radio wave strength is a value related to the strength of radio waves that are emitted from the selected AP and received by the communication apparatus 151. The AP selected from the AP list displayed in step S314 will hereinafter be referred to as a selected AP.

The first application initially refers to the information stored in the storage area that the first application can refer to in step S305, and acquires from the storage area the second radio wave strength that is the value related to the strength of the radio waves from the selected AP and is the signal level.

In step S1402, the first application determines whether the second radio wave strength is less than a second threshold. The second threshold is a value freely set by the first application. Specifically, the second threshold is a value based on 50% of a value of 100 that is the maximum value of the signal level to be acquired in step S305.

In a case where the first application determines that the determination result is yes (YES in step S1402), the processing proceeds to step S1403. In a case where the first application determines that the determination result is no (NO in step S1402), the processing of this flowchart ends.

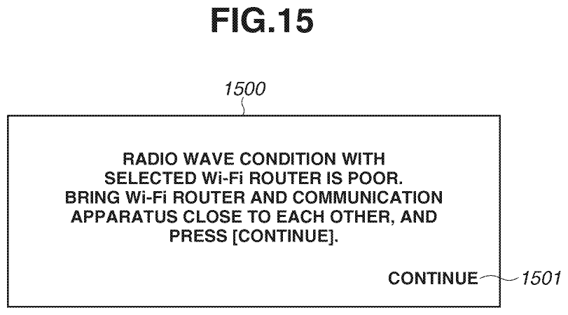

In step S1403, the first application displays a notification screen for notifying the user to bring the selected AP and the communication apparatus 151 close to each other. FIG. 15 illustrates an example of the notification screen displayed in this processing. A screen 1500 includes text for notifying the user to bring the selected AP and the communication apparatus 151 close to each other, and a button 1501 for continuing the connection setup processing. The displayed text includes a message indicating that the radio wave condition between the selected AP and the communication apparatus 151 is poor and a message for prompting the user to bring the selected AP and the communication apparatus 151 close to each other and recheck the radio wave condition. The radio wave condition in this processing corresponds to the radio wave condition of the wireless communication between the selected AP and the communication apparatus 151. In the present embodiment, the radio wave condition is determined to be poor in a case where the second radio wave strength acquired in step S305 is less than the second threshold. In other words, the poor radio wave condition is equivalent to the second radio wave strength being weak. The screen 1500 may include a button for acquiring the second radio wave strength again. Based on this button being operated, the first application determines whether the second radio wave strength is less than the second threshold, and in a case where the second radio wave strength is less than the second threshold, displays the screen 1500 again. The screen 1500 may include a button for having the user select an AP to be the connection target of the communication apparatus 151 from the AP list again. Based on this button being operated, the first application displays the screen 1600 again.

In the present embodiment, the processing for checking the radio wave strength of the selected AP is performed at some point between when the connection between the communication apparatus 151 and the terminal apparatus 101 is established and when the setting information corresponding to an AP is transmitted to the communication apparatus 151.

In step S1404, the first application determines whether the button 1303 for continuing the connection setup processing is operated. In a case where the first application determines that the determination result is yes (YES in step S1404), the processing of this flowchart ends. In a case where the first application determines that the determination result is no (NO in step S1404), the processing returns to step S1404 and the first application waits to accept an operation on the screen 1500 from the user. In this processing, in a case where the first application determines that the determination result is yes, the first application, instead of ending the processing of this flowchart, may constantly acquire the second radio wave strength during the connection setup processing, and display the screen 1500 each time based on the second radio wave strength falling below the second threshold.

In the present embodiment, the first application acquires the second radio wave strength from the communication apparatus 151 in step S305, and determines whether the acquired second radio wave strength is less than the second threshold. However, such a configuration is not restrictive. For example, the first application may acquire the RSSI value of the selected AP from the communication apparatus 151 and make a threshold determination using the RSSI value. The first application may perform processing for converting the RSSI value acquired from the communication apparatus 151 into a signal level, and make a threshold determination using the signal level.

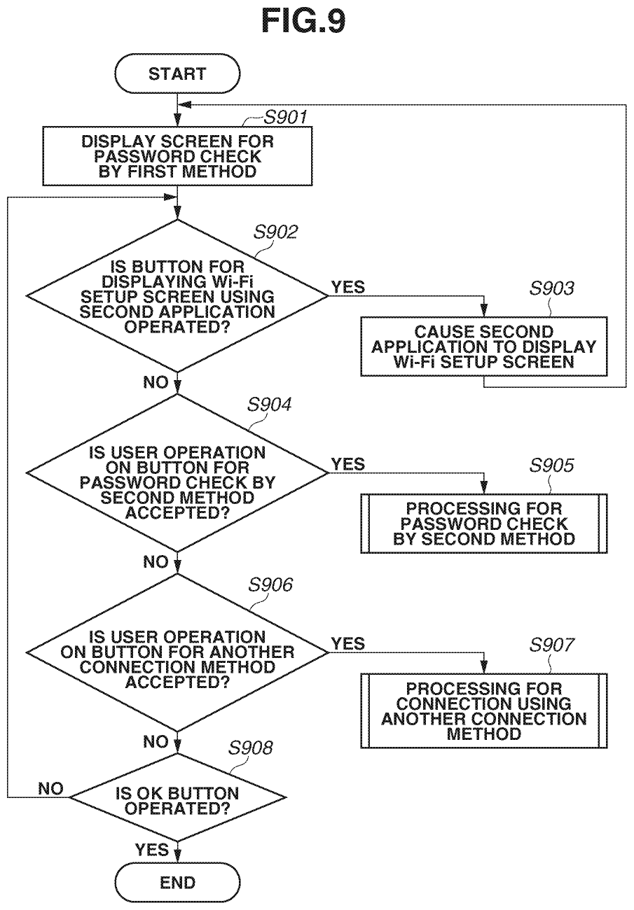

FIG. 9 is a flowchart illustrating an example of processing that the terminal apparatus 101 performs using the first application in the present embodiment. The processes of the flowchart of FIG. 9 are implemented, for example, by the CPU 103 loading the first application stored in the memory such as the ROM 104 into the RAM 105 and executing the first application. The processing of this flowchart corresponds to the processing of steps S324 and S1003.

In step S901, the first application displays a screen for password check by the first method. In the present embodiment, the screen for password check by the first method is a predetermined screen describing a method for checking the AP password on the Wi-Fi setup screen displayed by the second application. FIGS. 6A and 6B illustrate examples of the screen displayed in this processing. In the present embodiment, the screen for password check by the first method and a screen for password check by the second method to be described below are not webpages displayed by a web browser via the Internet. In other words, the screens for password check are displayed on the first application using information retained by the first application in advance. Examples of the web browser include an internal browser included in the first application and a browser included in a browser application different from the first application. However, such a configuration is not restrictive. The screens for password check may be webpages displayed by a web browser. The screens for password check may be displayed using a pop-up over the AP list.

Processing in a case where the OS of the terminal apparatus 101 is Android OS will now be described. FIG. 6A illustrates a screen for password check that is displayed in a case where the OS of the terminal apparatus 101 is Android OS and the first application is an application for Android OS. A screen 600 includes an area 601 describing a method for checking the AP password on the Wi-Fi setup screen displayed by the second application that is compatible with Android OS (hereinafter, first password check method). The screen 600 also includes a button 602 for displaying the Wi-Fi setup screen using the second application, a button 603 for password check by the second method, a button 604 for another connection method, and an OK button 605. The area 601 displays text describing operations for checking the password on a Wi-Fi setup screen compatible with Android OS as text indicating the first password check method. Specifically, for example, the area 601 displays text indicating that the Wi-Fi setup screen is to be opened and the wireless LAN router (Wi-Fi router) running the AP identified as the connection target of the communication apparatus 151 is to be selected. For example, the area 601 displays text indicating that a share button for displaying the password of the selected router on the Wi-Fi setup screen is to be tapped. The area 601 may display the SSID of the AP identified as the connection target of the communication apparatus 151. The SSID of the AP identified as the connection target of the communication apparatus 151 is, in other words, the SSID of the AP corresponding to the password to be checked on the Wi-Fi setup screen. The area 601 also displays text indicating that the password displayed on the Wi-Fi setup screen is to be copied and the copied password is to be pasted back to the first application. The area 601 may display text prompting the user to return to the first application (cause the first application to transition to the foreground again) after checking the password. Depending on the type of the terminal apparatus 101 (type of the Android terminal), the function for checking the password on the Wi-Fi setup screen may not be implemented. Depending on the type of the terminal apparatus 101, the function of copying the password displayed on the Wi-Fi setup screen may not be implemented. The screen 600 may therefore include messages indicating such possibilities. The screen 600 may include a message for prompting the user to check the password by referring to the Wi-Fi router or the manual of the Wi-Fi router in a case where the password is unable to be checked on the Wi-Fi setup screen. The screen 600 may include a message for prompting the user to try another connection method. As described above, the first application displays on the screen 600 the method for checking the AP password on the Wi-Fi setup screen. However, in a case where the user fails to check the password on the Wi-Fi setup screen by following the text displayed on the screen 600, the user is unable to recognize the AP password and input the password to the password input screen 500. In the present embodiment, the screen 600 thus displays the button 603 and the button 604 for another connection method in addition to the area 601.

In step S902, the predetermined application determines whether the button 602 for displaying the Wi-Fi setup screen using the second application is operated. In a case where the first application determines that the determination result is yes (YES in step S902), the processing proceeds to step S903. In a case where the first application determines that the determination result is no (NO in step S902), the processing proceeds to step S904.

In step S903, the predetermined application performs processing for launching the second application and causing the second application to display the Wi-Fi setup screen. Once the Wi-Fi setup screen is displayed, the first application transitions to the background. In a case where a return button of the terminal apparatus 101 is operated on the screen displayed by the second application, the first application transitions to the foreground again, and the processing returns to step S901 to display the screen for password check by the first method.

In step S904, which is performed when the determination result of step S902 is no, the first application determines whether the button 603 for password check by the second method is operated.

The button 603 is a button similar to the button 504 for password check by the second method, included in the password input screen 500. In a case where the first application determines that the determination result is yes (YES in step S904), the processing proceeds to step S905. In a case where the first application determines that the determination result is no (NO in step S904), the processing proceeds to step S906. Details of the processing of step S905 will be described below. The processing of step S905 is similar to the processing of step S326, and will be described below.

In step S906, which is performed when the determination result of step S904 is no, the first application determines whether the button 604 for another connection method is operated. In a case where the first application determines that the determination result is yes (YES in step S904), the processing proceeds to step S907. In a case where the first application determines that the determination result is no (NO in step S904), the processing proceeds to step S908. In steps S907 and S328, similar processing is performed. Details of the processing of step S907 are similar to those of step S328, and will be described below.

In step S908, which is performed when the determination result of step S906 is no, the first application determines whether the OK button 605 is operated. In a case where the first application determines that the determination result is yes (YES in step S908), the processing proceeds to step S321. In a case where the first application determines that the determination result is no (NO in step S908), the processing returns to step S902, and the first application waits for receipt of any operation.

Next, processing in the case where the OS of the terminal apparatus 101 is iOS or iPadOS will be described. FIG. 6B illustrates a screen for password check to be displayed in a case where the OS of the terminal apparatus 101 is iOS or iPadOS and the first application is an application for iOS or an application for iPadOS. A screen 610 includes an area 611 describing a method for checking the password of the AP on a Wi-Fi setup screen displayed by a second application compatible with iOS or iPadOS (hereinafter, a second password check method). The screen 610 also includes a button 612 for password check by the second method, and an OK button 613. The area 611 displays text describing operations for checking a password on the Wi-Fi setup screen compatible with iOS or iPadOS as text describing the second password check method. The screen 610 may display the SSID of the AP identified as the connection target of the communication apparatus 151. The area 611 may display text prompting the user to return to the first application (cause the first application to transition to the foreground again) after checking the password.

Having viewed the text, the user launches the second application from the home screen and the like of the terminal apparatus 101, and performs the operations described in the text for password check. Having checked the password, the user runs the first application in the foreground again and operates the OK button 613 to input the password to the password input screen 500 displayed by the first application. All terminal apparatuses equipped with iOS of a predetermined version or later or iPadOS of a predetermined version or later have the function of checking a password on a Wi-Fi setup screen. Unlike the screen 600, the screen 610 therefore does not include a button for another connection method. In the present embodiment, in a case where the OS of the terminal apparatus 101 is iOS or iPadOS, the processing thus proceeds to step S908 without performing processing related to another connection method like the processing of steps S906 and S907. However, such a configuration is not restrictive. The screen 610 may also include a button for another connection method, and the processing of steps S906 and S907 may be performed. Terminal apparatuses equipped with iOS or iPadOS are unable to launch the second application based on instructions from the first application. Unlike the screen 600, the screen 610 therefore does not include a button for displaying the Wi-Fi setup screen. In the present embodiment, in a case where the OS of the terminal apparatus 101 is iOS or iPadOS, the processing thus proceeds to step S904 without performing the processing for displaying the Wi-Fi setup screen using the second application as in steps S902 and S903. However, such a configuration is not restrictive. The screen 610 may also include a button for displaying the Wi-Fi setup screen if it becomes possible, even on terminal apparatuses equipped with the iOS or iPadOS, to launch the second application based on instructions from the first application. The processing of steps S902 and S903 may be performed. In the present embodiment, the text describing the first password check method and the text describing the second password check method are different. However, such a configuration is not restrictive, and the text describing the first password check method and the text describing the second password check method may be the same. As described above, the first application displays, on the screen 610, the method for checking the AP password on the Wi-Fi setup screen. However, in a case where the user fails to check the password on the Wi-Fi setup screen by following the text displayed on the screen 610, the user is unable to recognize the password of the AP and input the password to the password input screen 500. In the present embodiment, the screen 610 thus displays a button 612 for checking the password by referring to the Wi-Fi router or the manual of the Wi-Fi router in addition to the area 611 describing the method for checking the AP password on the Wi-Fi setup screen.

In step S904 to which the processing proceeds without the processing of steps S902 and S903 being performed, the first application determines whether the button 612 for password check by the second method is operated.

The button 612 is a button similar to the button 504 for password check by the second method included in the password input screen 500 and the button 603 for password check by the second method included in the screen 600. In a case where the first application determines that the determination result is yes (YES in step S904), the processing proceeds to step S905. In a case where the first application determines that the determination result is no (NO in step S904), the processing proceeds to step S906. Details of the processing of step S905 will be described below.

In step S908 to which the processing proceeds without the processing of steps S906 and S907 being performed, the first application determines whether the OK button 613 is operated. In a case where the first application determines that the determination result is yes (YES in step S908), the processing proceeds to step S321. In a case where the first application determines that the determination result is no (NO in step S908), the processing returns to step S902, and the first application waits for receipt of any operation.

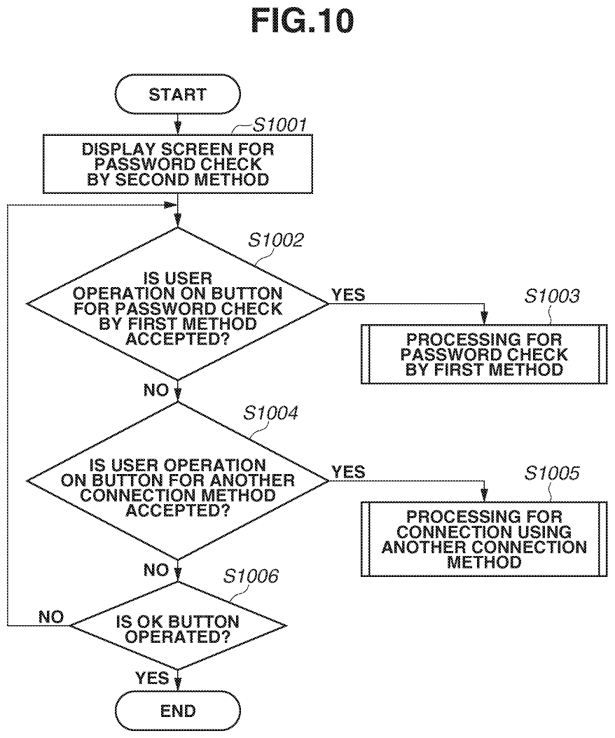

FIG. 10 is a flowchart illustrating an example of processing that the terminal apparatus 101 performs using the first application in the present embodiment. The processes of the flowchart of FIG. 10 are implemented, for example, by the CPU 103 loading the first application stored in the memory such as the ROM 104 into the RAM 105 and executing the first application. The processing of this flowchart corresponds to the processing of steps S326 and S905.

In step S1001, the first application displays the screen for password check by the second method. FIG. 11 illustrates an example of the screen displayed in this processing. A screen 1100 for password check by the second method includes an area 1101 describing a method for checking the AP password by referring to Wi-Fi router or the manual of the Wi-Fi router (hereinafter, router check method). The screen 1100 also includes a button 1102 for password check by the first method, a button 1103 for another connection method, and an OK button 1104. The area 1101 displays text describing operations for checking the password by referring to the Wi-Fi router or the manual of the Wi-Fi router. Specifically, for example, the area 1101 displays text indicating that the initial password of the AP is written on the Wi-Fi router or in the manual of the Wi-Fi router, as well as how the initial password is labeled on the Wi-Fi router or in the manual of the Wi-Fi router. A figure indicating the location where the initial password is written on the Wi-Fi router or in the manual of the Wi-Fi router is also displayed. The area 1101 may simply indicate, as a method for checking the initial password, that at least one of the Wi-Fi router and the manual of the Wi-Fi router is to be checked for the initial password. The area 1101 may also display text prompting the user to, after checking the password, operate the OK button 1104 and input the password to the password input screen 500. The area 1101 may include a message for prompting the user to check the password on the Wi-Fi setup screen in a case where the password is not found on the Wi-Fi router or in the manual of the Wi-Fi router. The area 1101 may include a message for prompting the user to try another connection method. As described above, the first application displays, on the screen 1100, the method for checking the AP password by referring to the Wi-Fi router or the manual of the Wi-Fi router. However, in a case where the user fails to find the password on the Wi-Fi router or in the manual of the Wi-Fi router by following the text displayed on the screen 1100, the user is unable to recognize the AP password. The user is unable to input the password to the password input screen 500, either. In the present embodiment, the screen 1100 thus displays the button 1102 for checking the password on the Wi-Fi setup screen and the button 1103 for another connection method in addition to the area 1101 describing the method for checking the AP password by referring to the Wi-Fi router or the manual of the Wi-Fi router.

In step S1002, the predetermined application determines whether the button 1102 for password check by the first method is operated. The button 1102 is similar to the button 503 for password check by the first method, included in the password input screen 500. In a case where the first application determines that the determination result is yes (YES in step S1002), the processing proceeds to step S1003. In a case where the first application determines that the determination result is no (NO in step S1002), the processing proceeds to step S1004. Details of the processing of step S1003 are similar to those of step S324, which are illustrated in FIG. 9.

In step S1004, which is performed when the determination result of step S1002 is no, the first application determines whether the button 1103 for another connection method is operated. In a case where the first application determines that the determination result is yes (YES in step S1004), the processing proceeds to step S1005. In a case where the first application determines that the determination result is no (NO in step S1004), the processing proceeds to step S1006.

Details of the processing of step S1005 are similar to those of steps S328 and S907, and will be described below.

In step S1006, which is performed when the determination result of step S1004 is no, the first application determines whether the OK button 1104 is operated. In a case where the first application determines that the determination result is yes (YES in step S1006), the processing proceeds to step S321. In a case where the first application determines that the determination result is no (NO in step S1006), the processing returns to step S1002, and the first application waits for receipt of any operation.

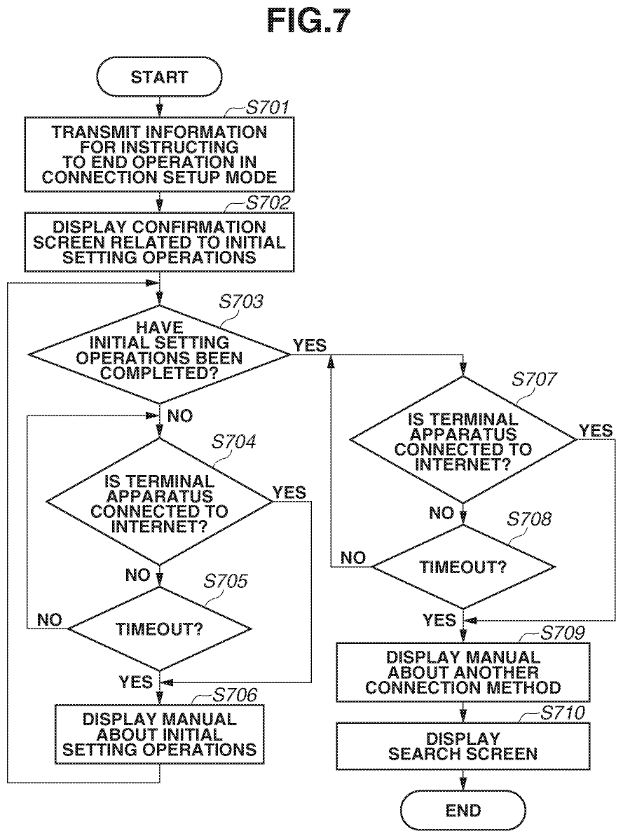

FIG. 7 is a flowchart illustrating an example of processing that the terminal apparatus 101 performs using the first application in the present embodiment. The processes of the flowchart of FIG. 7 are implemented, for example, by the CPU 103 loading the first application stored in the memory such as the ROM 104 into the RAM 105 and executing the first application. The processing of this flowchart corresponds to the processing of steps S328, S907, and S1005.

In step S701, the first application transmits to the communication apparatus 151 information for instructing to end operation in the connection setup mode. The communication apparatus 151 in response terminates the connection setup mode and resumes operation in the mode prior to the operation in the connection setup mode. With the connection setup mode terminated, the connection between the communication apparatus 151 and the terminal apparatus 101 is also disconnected. The terminal apparatus 101 reconnects to the predetermined AP that is the AP to which the terminal apparatus 101 has been connected before the connection to the communication apparatus 151, using the OS's reconnection function.

In step S702, the first application displays a confirmation screen for prompting the user to confirm whether initial setting operations on the communication apparatus 151 have been completed. The initial setting operations on the communication apparatus 151 are operations to be performed upon initial power-on (upon delivery) of the communication apparatus 151. In the present embodiment, the initial setting operations include, for example, the following:
removal of an orange tape from the communication apparatus 151
attachment of a print head to the communication apparatus 151
replenishment of the communication apparatus 151 with a recording agent (ink or toner)
replenishment of the communication apparatus 151 with sheets
date and time setting for the communication apparatus 151

Initial setting processing that the communication apparatus 151 performs in association with the initial setting operations includes, for example, the following:
print head cleaning processing
sheet Detection
registration processing (registration adjustment processing), which is processing for adjusting landing positions of ink on a sheet during printing
start of operation in the connection setup mode

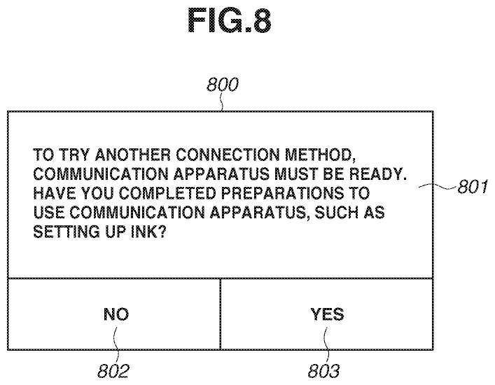

The confirmation screen can thus be said to be a screen for prompting the user to confirm whether the initial setting processing by the communication apparatus 151 has been completed. The operations included in the initial setting operations and the processes included in the initial setting processing are not limited to such a configuration, and may differ depending on the type of the communication apparatus 151, the printing method, etc. FIG. 8 illustrates an example of the screen displayed in this processing. A screen 800 includes a message 801, a NO button 802, and a YES button 803. The message 801 includes a message notifying that the initial setting operations on the communication apparatus 151 need to be completed to try another connection method, and a message for confirming whether the initial setting operations on the communication apparatus 151 have been completed. In a case where the initial setting operations on the communication apparatus 151 have been completed, the user operates the YES button 803. In a case where the initial setting operations on the communication apparatus 151 have not been completed, the user operates the NO button 802.

In step S703, the first application determines whether a user operation on the YES button 803 is accepted. In a case where a user operation on the NO button 802 is accepted, the determination result is no. In a case where the first application determines that the determination result is yes (YES in step S703), the processing proceeds to step S707. In a case where the first application determines that the determination result is no (NO in step S703), the processing proceeds to step S704.

In step S704, the first application determines whether the terminal apparatus 101 is connected to the Internet. As described above, the connection between the communication apparatus 151 and the terminal apparatus 101 is disconnected in step S701, whereby the OS of the terminal apparatus 101 performs the reconnection processing. However, the confirmation screen may be displayed before the completion of the reconnection with the AP via the Wi-Fi. In other words, the confirmation screen can be operated without the terminal apparatus 101 being connected to the Internet via the Wi-Fi connection to the AP. In such a case, a webpage is unable to be displayed in the processing of step S706. This determination is performed to properly display the webpage in the processing of step S706. Specifically, in this processing, the first application executes an API for checking whether the terminal apparatus 101 is connected to the Internet, and receives from the OS a notification indicating whether the terminal apparatus 101 is connected to the Internet. Based on the content of the received notification, the first application then performs this determination. The notification from the OS indicates that the terminal apparatus 101 is connected to the Internet in a case where the terminal apparatus 101 is connected to the Internet via the Wi-Fi connection with the AP.

The notification from the OS may also indicate that the terminal apparatus 101 is connected to the Internet even in a case where the terminal apparatus 101 is not connected to the Internet via the Wi-Fi connection with the AP but is connected to the Internet via mobile data communication. The processing of this determination is not limited to the foregoing configuration. For example, depending on the OS of the terminal apparatus 101, the notification indicating whether the terminal apparatus 101 is connected to the Internet is not available from the OS. Specifically, for example, the first application can receive the notification in a case where the OS of the terminal apparatus 101 is iOS or iPadOS, but not in a case where the OS of the terminal apparatus 101 is Android OS. Then, in a case where the first application in this determination is an Android OS application, the first application may call an API for checking the SSID of the AP to which the terminal apparatus 101 is currently connected. The first application then receives from the OS a notification indicating the SSID of the AP to which the terminal apparatus 101 is currently connected. In a case where the received notification indicates an SSID different from an SSID of the AP enabled by the communication apparatus 151 operating in the connection setup mode, the first application may determine yes in this determination. In a case where the received notification indicates the SSID of the AP run by the communication apparatus 151 operating in the connection setup mode, the first application may determine no in this determination. In other words, this determination may be a determination as to whether the terminal apparatus 101 is currently connected to an AP different from that enabled by the communication apparatus 151 operating in the connection setup mode. Such a determination may be performed even if the first application is an iOS application or an iPadOS application. The first application may determine that the determination is yes in a case where the received notification indicates the SSID of the predetermined AP, and determine that the determination result is no in a case where the received notification indicates a different SSID. In a case where the first application determines that the determination result is yes (YES in step S704), the processing proceeds to step S706. In a case where the first application determines that the determination result is no (NO in step S704), the processing proceeds to step S705.

In step S705, the first application determines whether the time elapsed since the acceptance of the operation on the confirmation screen displayed in step S702 has exceeded a predetermined threshold. In other words, the first application determines whether the time elapsed since the acceptance of the operation on the confirmation screen displayed in step S702 has reached a timeout. The predetermined threshold is 10 sec, for example. In a case where the first application determines that the determination result is yes (YES in step S705), the processing proceeds to step S706. In a case where the first application determines that the determination result is no (NO in step S705), the processing returns to step S704.

In step S706, the first application performs processing for displaying a manual about the initial setting operations of the communication apparatus 151. Specifically, the first application displays a webpage displaying the manual about the initial setting operations of the communication apparatus 151, using the internal browser (in-app browser) of the first application. The information for displaying this webpage is acquired from a predetermined server via Internet connection. The webpage is thus successfully displayed when the communication apparatus 151 is connected to the Internet. When the communication apparatus 151 is not connected to the Internet, the webpage is not successfully displayed, and the browser displays a screen notifying that the communication apparatus 151 is not connected to the Internet. In the present embodiment, the first application can continue operating in the foreground by the internal browser of the first application displaying the webpage. The manual about the initial setting operations of the communication apparatus 151 includes details of specific operation methods of the respective operations to be performed as the initial setting operations of the communication apparatus 151 in order. The first application may display a webpage for selecting the model of the communication apparatus 151 before displaying the webpage displaying the manual about the initial setting operations of the communication apparatus 151. The first application then may be configured to, when the model is selected on the page, display the manual about the initial setting operations corresponding to the selected model. The manual about the initial setting operations of the communication apparatus 151 may be displayed by a browser outside the first application rather than the internal browser of the first application. In such a case, the external browser that displays the manual transitions to the foreground, and the first application transitions to the background. Instead of being displayed as a webpage acquired via the Internet, the manual about the initial setting operations of the communication apparatus 151 may be displayed by the first application as contents that the first application retains in advance, without using a browser. The screen displayed by the internal browser of the first application is closed by the user operating a close button on the screen.

The screen displayed by the internal browser of the first application is displayed over the confirmation screen displayed in step S702. Closing the screen displayed by the internal browser of the first application thus enables the terminal apparatus 101 to accept operations on the confirmation screen again. After this processing, the processing therefore returns to step S703.

In the foregoing description, in a case where the determination result of step S705 is yes, the processing proceeds to step S706. However, such a configuration is not restrictive. In a case where the determination result of step S705 is yes, the first application may display a message and the like notifying that the communication apparatus 151 is not connected to the Internet on the screen of the first application without attempting webpage display using a browser.

In step S707, which is performed when the determination result of step S703 is yes, the first application determines whether the terminal apparatus 101 is connected to the Internet. This processing is similar to the processing of step S704. In a case where the first application determines that the determination result is yes (YES in step S707), the processing proceeds to step S709. In a case where the first application determines that the determination result is no (NO in step S707), the processing proceeds to step S708.

In step S708, the first application determines whether the time elapsed since the acceptance of the operation on the confirmation screen displayed in step S702 has exceeded a predetermined threshold. This processing is similar to the processing of step S705. In a case where the first application determines that the determination result is yes (YES in step S708), the processing proceeds to step S709. In a case where the first application determines that the determination result is no (NO in step S708), the processing returns to step S707.

In step S709, the first application performs processing for displaying a manual about another connection method. Specifically, the first application displays a webpage displaying the manual about another connection method, using the internal browser (in-app browser) of the first application. The information for displaying this webpage is acquired from the predetermined server via Internet connection. The webpage is thus successfully displayed when the communication apparatus 151 is connected to the Internet. When the communication apparatus 151 is not connected to the Internet, the webpage is not successfully displayed, and the browser displays a screen notifying that the communication apparatus 151 is not connected to the Internet. In the present embodiment, the first application can continue operating in the foreground by the internal browser of the first application displaying the webpage. The manual about another connection method includes details of a specific operation method for establishing a connection between the communication apparatus 151 and the AP using another connection method. Specific examples of another connection method include a method for displaying, on the screen of the communication apparatus 151, a list of APs discovered by the communication apparatus 151 through a search and establishing a Wi-Fi connection between an AP selected by the user from the displayed list and the communication apparatus 151. Specific examples of another connection method also include a method for establishing a Wi-Fi connection between the AP and the communication apparatus 151 by Wi-Fi Protected Setup (WPS). Specific examples of another connection method also include a method for establishing a wired LAN connection between the AP and the communication apparatus 151 using a LAN cable. The first application may display a webpage for selecting the model of the communication apparatus 151 before displaying the webpage displaying the manual about another connection method. The first application then may be configured to, when the model is selected on the page, display the manual about another connection method corresponding to the selected model. The manual about another connection method may be displayed by a browser outside the first application rather than the internal browser of the first application. In such a case, the external browser that displays the manual transitions to the foreground, and the first application transitions to the background. Instead of being displayed as a webpage acquired via the Internet, the manual about another connection method may be displayed by the first application as contents that the first application retains in advance, without using a browser.

In step S710, the first application displays a search screen for searching the Wi-Fi network to which the terminal apparatus 101 is connected for a communication apparatus 151. The search screen is displayed under the internal browser, with the webpage being displayed by the internal browser. The search screen thus appears when the internal browser is closed by operating the close button. The search screen includes a button for issuing an instruction to start searching the Wi-Fi network to which the terminal apparatus 101 is connected for a communication apparatus 151. When this button is pressed, the first application searches the Wi-Fi network to which the terminal apparatus 101 is connected for a communication apparatus 151. The first application then displays a list of communication apparatuses 151 discovered by the search. The first application displays only communication apparatuses 151 corresponding to the first application among a plurality of communication apparatuses 151 discovered by the search. Communication apparatuses 151 corresponding to the first application are ones provided by the vendor who provides the first application. The search may be performed by a method in which only communication apparatuses 151 provided by the vendor who provides the first application are discovered and communication apparatuses 151 provided by other vendors are not. When any one of the communication apparatuses 151 is selected from the displayed list, the first application acquires information about the selected communication apparatus 151 from the selected communication apparatus 151 via the Wi-Fi network to which the terminal apparatus 101 is connected. The first application then registers the selected communication apparatus 151 with itself. Then, the processing of this flowchart ends.

### Second Embodiment

In the present embodiment, methods for acquiring a value related to the strength of radio waves between a terminal apparatus 101 and a communication apparatus 151 are switched based on whether the terminal apparatus 101 is one supporting a Wi-Fi station/station (STA/STA) Concurrency function (hereinafter, STA/STA function). In the present embodiment, there are a terminal apparatus 101-a that supports the STA/STA function and a terminal apparatus 101-b that does not support the STA/STA function. In other words, a terminal apparatus supporting the STA/STA function and a terminal apparatus not supporting the STA/STA function are respective different terminal apparatuses. In the present embodiment, the communication apparatus 151 is similar to the communication apparatus according to the first embodiment unless otherwise specified.

### STA/STA Function

Some Wi-Fi compatible terminals that can execute a first application to perform connection setup processing support the STA/STA function. The STA/STA function is a feature introduced in Android 12, a feature that enables a Wi-Fi compatible terminal to establish concurrently (in parallel) a plurality of connections with Wi-Fi networks where the own apparatus operates and functions as a client. The client here refers to a station (STA). In other words, the STA/STA function is a function that enables the Wi-Fi compatible terminal to concurrently maintain connections with a plurality of APs. To use the STA/STA function, not only the OS version but the hardware of the information processing apparatus on which the OS is installed needs to support the STA/STA function. In the present embodiment, a terminal apparatus 101 is a terminal supporting the STA/STA function.

Even when a Wi-Fi compatible terminal concurrently establishes a plurality of connections with Wi-Fi networks, one application is unable to communicate with the plurality of Wi-Fi networks at the same time. In other words, when a Wi-Fi compatible terminal concurrently establishes a plurality of connections with Wi-Fi networks using the STA/STA function, a given application can use one of the plurality of Wi-Fi networks for communication. However, while concurrently maintaining the plurality of connections with the Wi-Fi networks using the STA/STA function, the Wi-Fi compatible terminal operates in a state of being unable to use the rest of the plurality of Wi-Fi networks. The state where a Wi-Fi compatible terminal has a plurality of connections concurrently established with Wi-Fi networks is equivalent to a state where the Wi-Fi compatible terminal simultaneously belongs to the plurality of Wi-Fi networks.

A network formed by the communication apparatus 151 operating in a connection setup mode is a network not connected to the Internet. A network not connected to the Internet will hereinafter be referred to as a local network. In other words, the terminal apparatus 101 is unable to perform Internet communication via a local network.

Which network a given application uses for communication in a state where a plurality of Wi-Fi networks is concurrently established using the STA/STA function is determined by the OS. A first network set by the user on a Wi-Fi setup screen of the terminal apparatus 101 with a plurality of Wi-Fi networks concurrently established using the STA/STA function will be referred to as a primary network. A second network connected under a connection instruction from an application with the plurality of Wi-Fi networks concurrently established using the STA/STA function will be referred to as a secondary network. Here, the OS has not accepted any instructions from the application regarding the setting of the network to be used for communication.

The OS in such a state sets a network connected to the Internet among the plurality of networks as the network to be used for the communication of the application by priority over networks not connected to the Internet. In other words, the default network set by the OS for communication use is an Internet-connected network. In a case where the network formed by the communication apparatus 151 operating in the connection setup mode is in the following state, the network is therefore not set as the network to be used for the communication of the first application. The state is where there is a plurality of Wi-Fi networks concurrently established using the STA/STA function and the OS has not received any instructions from the first application regarding the setting of the network to be used for communication. In other words, in the state where a plurality of Wi-Fi networks is concurrently established using the STA/STA function, the network formed by the communication apparatus 151 operating in the connection setup mode needs to be set as the network for the first application to use for communication.

In the present embodiment, the number of networks with which connections can be concurrently maintained using the STA/STA function is two. Possible combinations of networks with which connections can be concurrently maintained using the STA/STA function are a local network and a local network, and a local network and an Internet-connected network. In other words, with a combination of an Internet-connected network and an Internet-connected network, connections are unable to be concurrently maintained using the STA/STA function. However, such a configuration is not restrictive. The number of networks with which connections can be concurrently maintained using the STA/STA function may be two or more, and a combination of an Internet-connected network and an Internet-connected network may be concurrently maintained.

### Issue to be Solved by Present Embodiment

In the conventional mechanism, when a network (NW) connection is instructed by an application, the OS stores the connection-instructing application and the connection-instructed NW (secondary NW) in association with each other. When information about radio wave strength is requested by an application, the OS notifies the requesting application of information about the NW corresponding to the requesting application based on the stored association (association between the application and the secondary NW). There have been cases where in a case where the application and the secondary NW are not linked for some reason, the radio wave strength of the primary NW may be notified from the OS to the application. This has resulted in the display of a notification about the radio wave strength of a target different from the communication apparatus to which the application wants to transmit information (fourth issue).

To solve such an issue, in a case where the terminal apparatus is connected to a plurality of NWs, the first application performs processing for enabling the acquisition, from the OS, of the radio wave strength of the communication apparatus to which the application is to transmit information, regardless of whether a primary NW or a secondary NW.

With the terminal apparatus 101 supporting the STA/STA function, there have been cases where even when the application issues an instruction to acquire the value related to the radio wave strength of the secondary NW again, the updated radio wave strength of the secondary NW is unavailable from the OS. The secondary NW refers to the NW formed by the communication apparatus 151 that is operating in the connection setup mode and connected to the terminal apparatus 101 under a connection instruction from the application. In such a case, the first application has displayed a button for accepting the instruction to acquire the value related to the radio wave strength of the secondary NW again. In other words, in the conventional mechanism, the first application has accepted the user useless operation of pressing the button (issue 5). In view of this, the first application performs processing for controlling whether to accept the instruction to acquire the radio wave strength again, based on whether the terminal apparatus supports the STA/STA function.

The present disclosure does not necessarily solve all the foregoing issues, and may solve some of the foregoing issues. In other words, the present disclosure does not need to perform all the processes for solving the foregoing issues, and may perform some of the processes for solving the foregoing issues.

### Processing That First Application Performs in Present Embodiment

In the present embodiment, like the first embodiment, the first application performs the processing of the flowcharts of FIGS. 3A and 3B. The first application may be run on the terminal apparatus 101-a or on the terminal apparatus 101-b. The processes of the flowcharts of FIGS. 3A and 3B are implemented, for example, by a CPU 103 loading the first application stored in a memory such as a ROM 104 into a RAM 105 and executing the first application. The flowcharts of FIGS. 3A and 3B are started based on an operation for performing connection setup processing being performed on a screen displayed by the first application.

The flowcharts of FIGS. 3A and 3B may also be started in response to the launching of the first application.

In the present embodiment, details of the processing of steps S303 and S304 for the first application to perform are different from those in the first embodiment. The processing of steps S301, S302, and S305 to S331 for the first application to perform is similar to the processing of the first embodiment. In the present embodiment, a description of the processing of steps S301, S302, and S305 to S331 will thus be omitted. Details of the processing of steps S303 and S304 performed in the present embodiment will now be described.

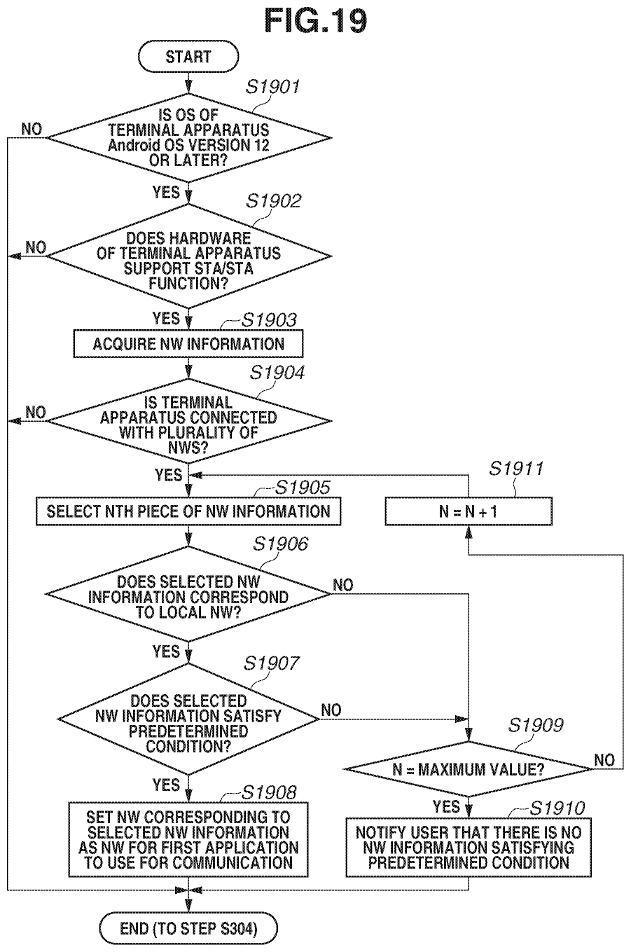

In step S303, the first application performs processing for establishing a connection between the communication apparatus 151 operating in the connection setup mode and the terminal apparatus 101. In a case where the terminal apparatus 101 supports the STA/STA function and is connected with the AP 131, the first application establishes a connection between the terminal apparatus 101 and the communication apparatus 151 while maintaining the connection between the terminal apparatus 101 and the AP 131. In a case where the terminal apparatus 101 does not support the STA/STA function and is connected with the AP 131, the first application disconnects the connection between the terminal apparatus 101 and the AP 131, and establishes a connection between the terminal apparatus 101 and the communication apparatus 151. In this processing, after the completion of the connection between the terminal apparatus 101 and the communication apparatus 151, the first application configures settings related to the NW to be used for communication. Specifically, the first application sets the NW formed by the communication apparatus 151 as the NW for the first application to use for communication. Details of this setting will now be described with reference to FIG. 19.

FIG. 19 is a flowchart illustrating a processing procedure that the first application performs after the connection between the terminal apparatus 101 and the communication apparatus 151 is established in step S303. The processes of the flowchart of FIG. 19 are implemented, for example, by the CPU 103 loading the first application stored in the memory such as the ROM 104 into the RAM 105 and executing the first application.

In step S1901, the first application determines whether the OS of the terminal apparatus 101 is Android OS. In a case where the OS of the terminal apparatus 101 is determined to be Android OS, the first application then determines whether the OS version of the terminal apparatus 101 is 12 or later. In a case where the first application performing this determination is one dedicated for Android, the determination as to whether the OS of the terminal apparatus 101 is Android OS may be omitted. The reason why whether the OS version of the terminal apparatus 101 is 12 or later is determined in this processing is that an API that can be called only on Android OS 12 or later is used in step S1902 to be described below. In a case where the OS of the terminal apparatus 101 is Android OS and the OS version of the terminal apparatus 101 is 12 or later (YES in step S1901), the processing proceeds to step S1902. In a case where the determination result is no (NO in step S1901), the processing of this flowchart ends, and the processing proceeds to step S304.

In step S1902, the first application determines whether the hardware of the terminal apparatus 101 supports the STA/STA function. In other words, in a case where the first application is run on the terminal apparatus 101-a, the determination of this processing is yes. On the other hand, in a case where the first application is run on the terminal apparatus 101-b, the determination of this processing is no. Specifically, in this processing, the first application calls an API for acquiring information about whether the hardware of the terminal apparatus 101 supports the STA/STA function. The first application then acquires the information about whether the hardware of the terminal apparatus 101 supports the STA/STA function from the OS. In a case where the first application determines that the hardware of the terminal apparatus 101 supports the STA/STA function (YES in step S1902), the processing proceeds to step S1903. In a case where the first application determines that the hardware of the terminal apparatus 101 does not support the STA/STA function (NO in step S1902), the processing of this flowchart ends, and the processing proceeds to step S304.

While in the present embodiment the determinations of steps S1901 and S1902 are separately performed, the determinations may be simultaneously performed in a single determination process.

In step S1903, the first application acquires NW information about all NWs to which the terminal apparatus 101 is connected. The NW information refers to identifiers of the communication partners of the terminal apparatus 101 that are the APs constituting the NWs. The identifiers of the APs will hereinafter be referred to also as NW identifiers. In the present embodiment, NW identifiers are identification information that the OS assigns to the respective NWs formed by the APs. In a case where the terminal apparatus 101 supports the STA/STA function and is connected with a plurality of NWs, a plurality of pieces of NW information corresponding to the respective NWs are acquired.

In step S1904, the first application determines whether the terminal apparatus 101 is connected with a plurality of NWs, based on the acquired NW information in step S1903. In a case where the terminal apparatus 101 is connected with a plurality of NWs (YES in step S1904), the processing proceeds to step S1905. In a case where the terminal apparatus 101 is connected with only one NW (NO in step S1904), the processing of this flowchart ends, and the processing proceeds to step S304.

The case where the terminal apparatus 101 is connected with a plurality of NWs corresponds to where the terminal apparatus 101 is maintaining the connection with the communication apparatus 151 operating in the connection setup mode and a connection with another AP. The case where the terminal apparatus 101 is connected with only one NW corresponds to where the terminal apparatus 101 is maintaining only the connection with the communication apparatus 151 operating in the connection setup mode.

In step S1905, the first application selects (identifies) one of the plurality of pieces of acquired NW information. In other words, the first application selects (identifies) an Nth piece of NW information among the plurality of pieces of acquired NW information. Here, the first application may preferentially select the piece of NW information corresponding to the NW that is currently set as the primary NW. The first application may preferentially select a piece of NW information acquired first, or a piece of NW information corresponding to a NW established first. The maximum value of N is the number of pieces of NW information acquired by the first application in step S1903. The initial value of N is 1.

In step S1906, the first application determines whether the selected NW information (Nth piece of NW information) is NW information corresponding to a local NW. As described above, the NW formed by the communication apparatus 151 operating in the connection setup mode is a local NW. Even a NW formed by an AP outside the communication apparatus 151 is determined as a local NW in a case where the NW is not connected to the Internet. This determination can be implemented, for example, by using an API provided for Android developers. In a case where the first application determines that the selected NW information is NW information corresponding to a local NW (YES in step S1906), the processing proceeds to step S1907. In a case where the determination result is no (NO in step S1906), the processing proceeds to step S1909.

In step S1907, the first application determines whether the selected NW information satisfies a predetermined condition. In other words, the first application determines whether the selected NW information is NW information corresponding to the NW formed by the communication apparatus 151 operating in the connection setup mode. Specifically, for example, the first application determines whether the information from which the NW corresponding to the selected NW information can be identified includes predetermined information corresponding to the NW formed by the communication apparatus 151 operating in the connection setup mode. Examples of the predetermined information include an IP address, SSID, basic service set identifier (BSSID), and MAC address.

The predetermined information shall be information that the first application retains in advance without acquisition from the communication apparatus 151. In the present embodiment, at least a part of the character string of the IP address is used as the predetermined information. An example of the at least part of the character string of the IP address is a character string common between communication apparatuses provided by a predetermined vendor. Specifically, the at least part of the character string of the IP address is a character string constituting a NW portion of the IP address. The first application, before performing this determination, acquires from the OS the information from which the NW corresponding to the selected NW information can be identified. Examples of the information from which the NW can be identified include the IP address assigned to the communication apparatus 151 operating in the connection setup mode, as well as the SSID, BSSID, and MAC address of the communication apparatus 151 operating in the connection setup mode. In the present embodiment, the information from which the NW can be identified is the IP address assigned to the communication apparatus 151 operating in the connection setup mode. The first application determines whether the IP address acquired from the OS includes the character string constituting the NW portion of the IP address retained by the first application. In other words, the case where the selected NW information is determined to satisfy the predetermined condition by this determination refers to a case where the information from which the NW corresponding to the selected NW information can be identified includes the foregoing predetermined information. The case where the selected NW information is determined to satisfy the predetermined condition refers to a case where the selected NW information is determined to be NW information corresponding to the NW formed by the communication apparatus 151 operating in the connection setup mode. That is, in a case where the first application determines that the selected NW information is NW information corresponding to the NW formed by the communication apparatus 151 operating in the connection setup mode (YES in step S1907), the processing proceeds to step S1908. In a case where the determination result is no (NO in step S1907), the processing proceeds to step S1909.

In the case where the selected NW information is the NW information corresponding to the NW formed by the communication apparatus 151 operating in the connection setup mode, the determination in step S1906 does not need to be performed. However, the determination of step S1906 can be completed before the determination of step S1907. The presence of the determination of step S1906 can thus expedite the processing in the case where the selected NW information is not NW information corresponding to a local NW. For such a reason, the present embodiment is configured to perform both the determinations of steps S1906 and S1907. However, such a configuration is not restrictive. The determination of step S1906 may be omitted so that the determination of step S1907 is performed after step S1905 or S1911.

In step S1908, the first application performs processing for setting the NW formed by the communication apparatus 151 operating in the connection setup mode as the NW for the first application to use for communication. In other words, the first application uses for its communication the NW that is formed by the communication apparatus 151 operating in the connection setup mode and corresponds to the selected NW information. The first application then operates the terminal apparatus 101 without using another NW different from the NW corresponding to the selected NW information. This processing is performed with the plurality of Wi-Fi NWs concurrently established using the STA/STA function. In this processing, specifically, for example, the first application instructs the OS to set the NW formed by the communication apparatus 151 operating in the connection setup mode as the NW for the first application to use for communication. The processing of this flowchart then ends, and the processing proceeds to step S304.

In step S1909, the first application determines whether N is the maximum value. In other words, the first application determines whether all the plurality of NWs corresponding to the plurality of pieces of acquired NW information have been selected in step S1905. In a case where the first application determines that all the plurality of NWs has been selected (YES in step S1909), the processing proceeds to step S1910. In a case where the determination result is no (NO in step S1909), the processing proceeds to step S1911.

In step S1910, the first application notifies the user that there is no NW information corresponding to the NW formed by the communication apparatus 151 operating in the connection setup mode. An example of the case where the processing proceeds to step S1910 is where the connection between the terminal apparatus 101 and the communication apparatus 151 fails to be established in step S303 and no connection is established between the communication apparatus 151 and the terminal apparatus 101. This processing may be omitted to maintain the current setting of the NW for the first application to use for communication without a change. The processing of this flowchart then ends, and the processing proceeds to step S304. After the end of the processing of this flowchart, the first application may also terminate the processing of the flowcharts of FIGS. 3A and 3B to abort the connection setup processing. The first application may issue a notification for prompting the user to establish a connection between the communication apparatus 151 operating in the connection setup mode and the terminal apparatus 101.

In step S1911, the first application increases N by 1. The first application then performs the processing of step S1905 and subsequent steps.

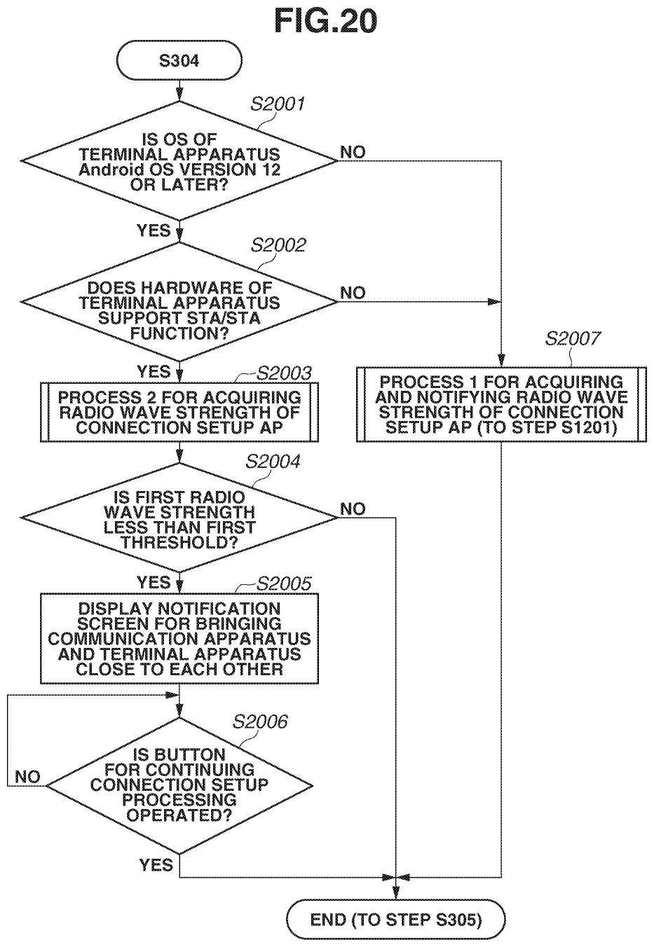

FIG. 20 is a flowchart illustrating a processing procedure of step S304 according to the present embodiment. The processes of the flowchart of FIG. 20 are implemented, for example, by the CPU 103 loading the first application stored in the memory such as the ROM 104 into the RAM 105 and executing the first application.

The processing of step S2001 is similar to the processing of step S1901. A description thereof will thus be omitted. In a case where the first application determines that the determination result is yes in this processing (YES in step S2001), the processing proceeds to step S2002. In a case where the first application determines that the determination result is no (NO in step S2001), the processing proceeds to step S2007.

The processing of step S2002 is similar to the processing of step S1902. A description thereof will thus be omitted.

In a case where the first application is run on the terminal apparatus 101-a, the determination of this processing is yes. On the other hand, in a case where the first application is run on the terminal apparatus 101-b, the determination of this processing is no. In a case where the first application determines that the determination result is yes in this processing (YES in step S2002), the processing proceeds to step S2003. In a case where the first application determines that the determination result is no (NO in step S2002), the processing proceeds to step S2007. The first application may store within the application the determinations of steps S1901 and S1902 performed when setting the NW formed by the communication apparatus 151 as the NW for the first application to use for communication. The first application then may refer to the stored determinations and thereby omit the processing of steps S2001 and S2002 during the execution of the flowchart of FIG. 20.

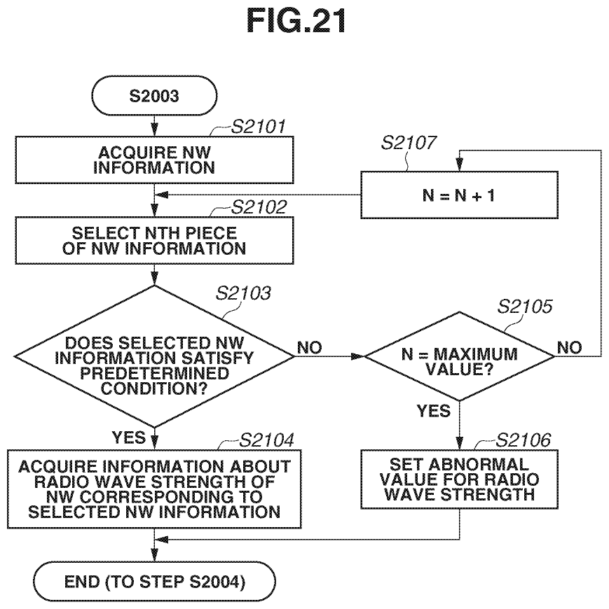

In step S2003, the first application performs processing for acquiring the radio wave strength of a connection setup AP. The connection setup AP refers to the AP enabled inside the communication apparatus 151 operating in the connection setup mode. In this processing, the first application acquires from the OS the information about the strength of radio waves that are emitted from the AP enabled inside the communication apparatus 151 operating in the connection setup mode and received by the terminal apparatus 101. Details of this processing will be described with reference to FIG. 21.

FIG. 21 is a flowchart illustrating a processing procedure of step S2003. The processes of the flowchart of FIG. 21 are implemented, for example, by the CPU 103 loading the first application stored in the memory such as the ROM 104 into the RAM 105 and executing the first application.

In step S2101, the first application acquires the NW information about all the NWs to which the terminal apparatus 101 is connected. This processing is similar to the processing of step S1903, and a description thereof will thus be omitted.

In step S2102, the first application selects (identifies) one of the plurality of pieces of acquired NW information. This processing is similar to the processing of step S1905, and a description thereof will thus be omitted.

In step S2103, the first application determines whether the selected NW information satisfies a predetermined condition. In other words, the first application determines whether the selected NW information is NW information corresponding to the NW formed by the communication apparatus 151 operating in the connection setup mode. This processing is similar to the processing of step S1907, and a description thereof will thus be omitted. In a case where the first application determines that the determination result is yes in this processing (YES in step S2103), the processing proceeds to step S2104. In a case where the first application determines that the determination result is no (NO in step S2103), the processing proceeds to step S2105.

In step S2104, the first application acquires from the OS the information about the radio wave strength of the NW corresponding to the selected NW information, using a second method. In the present embodiment, the NW corresponding to the selected NW information is the NW formed by the communication apparatus 151 operating in the connection setup mode.

The second method refers to a method of specifying an identifier corresponding to the NW information that is included in the NW information acquired in step S2101 and determined to satisfy the predetermined condition in step S2103, and calling an API for acquiring capability information about the NW corresponding to the specified identifier.

The capability information about the NW corresponding to the specified identifier is thereby acquired. The API used in the present embodiment to acquire capability information about a NW corresponding to a specified identifier is an API called “getNetworkCapabilities”.

In other words, in this processing, the first application acquires from the OS the capability information about the NW formed by the communication apparatus 151 operating in the connection setup mode. In the present embodiment, the capability information about the NW includes the information about the radio wave strength corresponding to the NW formed by the communication apparatus 151 operating in the connection setup mode.

A specific example of the information about the radio wave strength is an RSSI value. The radio wave strength corresponding to the NW formed by the communication apparatus 151 operating in the connection setup mode refers to information about the radio wave strength of communication between the terminal apparatus 101 and the communication apparatus 151 operating in the connection setup mode. Specifically, the information about the radio wave strength of communication between the terminal apparatus 101 and the communication apparatus 151 operating in the connection setup mode is information indicating the reception strength of radio waves that the terminal apparatus 101 receives from the communication apparatus 151 operating in the connection setup mode.

The first application then consults the capability information about the NW formed by the communication apparatus 151 for the information about the radio wave strength corresponding to the NW formed by the communication apparatus 151 operating in the connection setup mode. Specifically, the first application calls an API based on the program code “getSignalStrength”. By calling the API, the first application refers to the RSSI value in the capability information about the NW as the information about the radio wave strength corresponding to the NW formed by the communication apparatus 151 operating in the connection setup mode.

The first application also performs processing for causing the OS to convert the RSSI value referred to by the first application into a signal level value. Specifically, the first application calls an API for instructing the OS to convert the RSSI value referred to by the first application into a signal level value.

The API for instructing the OS to convert the RSSI value referred to by the first application into a signal level value refers to the third API or the fourth API described in the first embodiment. Since the processing for converting an RSSI value into a signal level value using the third API or the fourth API is described in step S1201, a description thereof will be omitted here. In the present embodiment, the first application controls the call for the third API or the fourth API based on the determination result of the Android OS version. However, the present disclosure is not limited to such a configuration. Only the fourth API may be called regardless of the OS version, without determining the Android OS version. By calling the foregoing third API or fourth API, the first application acquires from the OS the signal level value corresponding to the NW formed by the communication apparatus 151 operating in the connection setup mode as the information about the radio wave strength corresponding to the NW.

In a case where the NW information set for the first application to use for communication is stored within the application in the processing of step S1908, the first application may acquire the RSSI value in the stored information and convert the RSSI value into a signal level value. In such a case, the processing of steps S2101 to S2103 may be omitted.

As described above, the processing of step S2104 is processing for acquiring the information about the NW specified by the first application among the plurality of NWs to which the terminal apparatus 101 is currently connected. In other words, the NW identifier is specified by the first application.

In step S2105, which is performed when the determination result of step S2103 is no, the first application determines whether all the plurality of NWs corresponding to the plurality of pieces of acquired NW information have been selected in step S2102 and S2107. This processing is similar to the processing of step S1909, and a description thereof will thus be omitted. In a case where the first application determines that the determination result is yes (YES in step S2105), the processing proceeds to step S2106. In a case where the first application determines that the determination result is no (NO in step S2105), the processing proceeds to step S2107.

In step S2106, the first application sets an abnormal value for the radio wave strength. As employed herein, the abnormal value may be any value that prevents the radio wave strength from falling below a threshold in the subsequent processing of step S2004. Specifically, the abnormal value may be a value greater than or equal to the first threshold described in the first embodiment, which is a value based on 50% of the foregoing predetermined value or specific value.

In step S2107, which is performed when the determination result of step S2105 is no, the first application increases N by 1 as in step S1911. The first application then performs the processing of step S2102 and subsequent steps.

In step S2004, the first application determines whether the radio wave strength acquired in step S2104 is less than a first threshold. The radio wave strength acquired in step S2104 refers to the signal level value converted based on the RSSI value referred to by the first application. The first threshold corresponds to the first threshold described in the first embodiment. Specifically, the first threshold is a value that is freely set by the first application and is based on 50% of the foregoing predetermined value. Since this processing is similar to the processing of step S1202, a description thereof will be omitted. In a case where the first application determines that the first radio wave strength is less than the first threshold (YES in step S2004), the processing proceeds to step S2005. In a case where the first application determines that the first radio wave strength is not less than the first threshold (NO in step S2004), the processing of this flowchart ends. In the present embodiment, the first application performs the threshold determination using the signal level value. However, such a configuration is not restrictive. In other words, the first application may perform the threshold determination using the RSSI value. The first application, after referring to the RSSI value, may convert the RSSI value into a signal level value by itself. The first application then may perform the threshold determination using the converted signal level value.

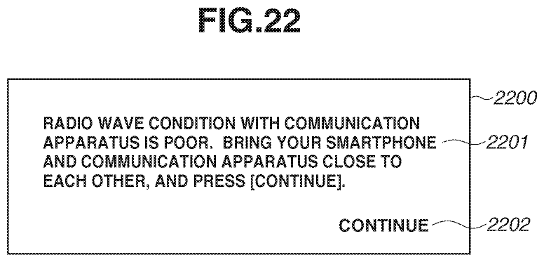

In step S2005, the first application displays a notification screen for notifying the user to bring the communication apparatus 151 and the terminal apparatus 101 close to each other. FIG. 22 illustrates an example of the notification screen displayed in this processing. A screen 2200 is a notification screen for issuing a notification to the user so that the communication apparatus 151 and the terminal apparatus 101 approach each other. The screen 2200 includes an area 2201 displaying text for notifying the user to bring either the communication apparatus 151 or the terminal apparatus 101 closer, and a button 2202 for continuing the connection setup processing. The area 2201 displays text for prompting the user to bring either the communication apparatus 151 or the terminal apparatus 101 closer and then continue the connection setup processing. The radio wave condition in this processing corresponds to the radio wave condition of the wireless communication between the communication apparatus 151 and the terminal apparatus 101. In the present embodiment, the radio wave condition is determined to be poor in a case where the first radio wave strength acquired in step S2104 is less than the first threshold. In other words, that the first radio wave strength acquired in step S2104 is less than the first threshold corresponds to the first radio wave strength being weak. In a case where the user wants to continue the connection setup processing, the user operates the button 2202 for continuing the connection setup processing. The screen 1300 for notifying the user to bring the communication apparatus 151 and the terminal apparatus 101 close to each other, described in the first embodiment, includes the button 1302 for rechecking the radio wave condition of the wireless communication between the communication apparatus 151 and the terminal apparatus 101. By contrast, the screen 2200 described in the present embodiment does not include a button for rechecking the radio wave condition of the wireless communication between the communication apparatus 151 and the terminal apparatus 101. In other words, the screen 2200 does not include a button for acquiring the radio wave strength of the communication apparatus 151 again. Like the button 1302, a button for acquiring the radio wave strength of the communication apparatus 151 again is an item for accepting an instruction to acquire the value related to the radio wave strength of the communication apparatus 151 that is the communication partner of the terminal apparatus 101 again. The reason why the screen 2200 does not include a button for acquiring the radio wave strength of the communication apparatus 151 again will now be described. In the first embodiment, the terminal apparatus 101 does not support the STA/STA function. The NW formed by the communication apparatus 151 in the connection setup mode, connected to the terminal apparatus 101, is thus set as a primary NW. In such a case, each time the first application issues an instruction to acquire the value related to the radio wave strength of the primary NW from the OS, the first application can acquire an updated value from the OS.

On the other hand, in the second embodiment, the terminal apparatus 101 supports the STA/STA function. The NW formed by the communication apparatus 151 in the connection setup mode, connected to the terminal apparatus 101, is set as a secondary NW. In such a case, when the first application issues an instruction to acquire the value related to the radio wave strength of the secondary NW from the OS for the first time, the first application can acquire the value. By contrast, when the first application subsequently issues a similar instruction, the first application is unable to acquire an updated value from the OS, and the same value as that acquired from the OS for the first time is returned. That is, even if a button for the first application to acquire the value related to the radio wave strength of the secondary NW from the OS is provided on the screen 2200, the first application is unable to acquire the updated value of the radio wave strength from the OS in response to user operation. As a result, even when the first application accepts the user operation, the user is unable to obtain updated information they desire. To prevent the user from performing useless operations in such a situation, the screen 2200 does not include a button for rechecking the radio wave condition of the wireless communication between the communication apparatus 151 and the terminal apparatus 101.

In other words, the button for acquiring the radio wave strength of the communication apparatus 151 again is displayed on the screen displayed by the first application based on the terminal apparatus 101 not supporting the STA/STA function. By contrast, the button for acquiring the radio wave strength of the communication apparatus 151 again is controlled not to be displayed on the screen displayed by the first application based on the terminal apparatus 101 supporting the STA/STA function.

In step S2006, the first application determines whether the button 2202 for continuing the connection setup processing is operated. In a case where the first application determines that the determination result is yes (YES in step S2006), this flowchart ends. In a case where the first application determines that the determination result is no (NO in step S2006), the processing returns to step S2006 and the first application waits to accept operation of the button 2202 for continuing the connection setup processing on the screen 2200 from the user.

While in step S2101 only the radio wave strength of the NW of the communication apparatus 151 is acquired, the radio wave strengths of all the NWs to which the terminal apparatus 101 is connected may be acquired. As described above, in the present embodiment, the STA/STA terminal can connect to two Wi-Fi NWs.

The processing of step S2007 is similar to the foregoing processing of FIG. 12. As described above in the first embodiment, the processing of step S1201 is processing for acquiring the information about the currently connected NW, and the NW identifier is not specified by the application.

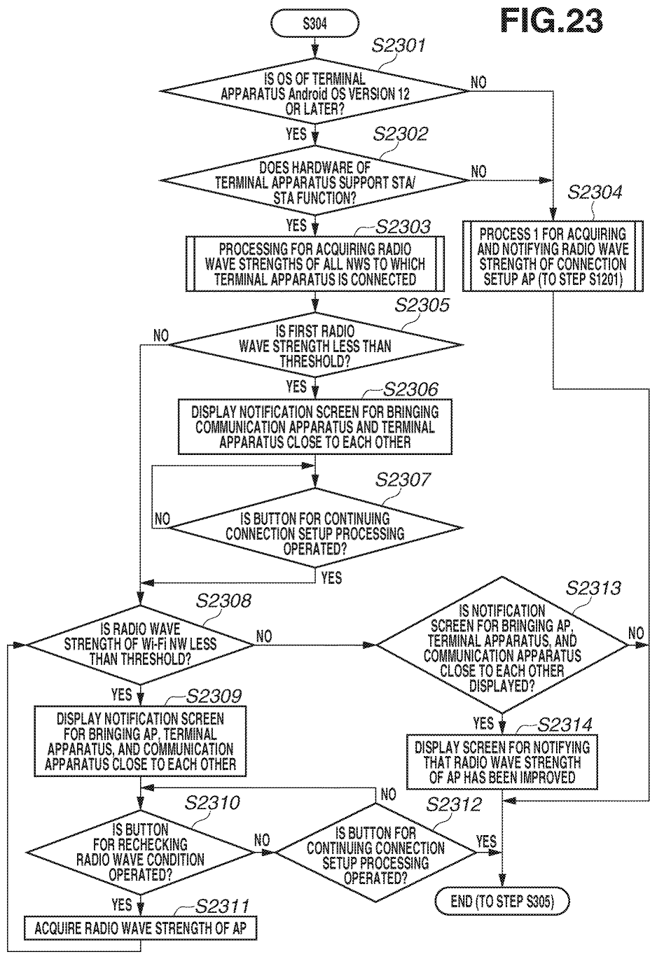

FIG. 23 illustrates the processing of step S304 in the case where the radio wave strengths of all the NWs to which the terminal apparatus 101 is connected are acquired.

The processing of steps S2301 and S2302 is similar to the processing of steps S1901 and S1902, and a description thereof will thus be omitted. In a case where, in step S2301, the first application determines that the determination result is yes (YES in step S2301), the processing proceeds to step S2302. In a case where the first application determines that the determination result is no (NO in step S2301), the processing proceeds to step S2304. In a case where, in step S2302, the first application determines that the determination result is yes (YES in step S2302), the processing proceeds to step S2303. In a case where the first application determines that the determination result is no (NO in step S2302), the processing proceeds to step S2304. The processing of step S2304 is similar to the processing of the flowchart illustrated in FIG. 12, and a description thereof will thus be omitted.

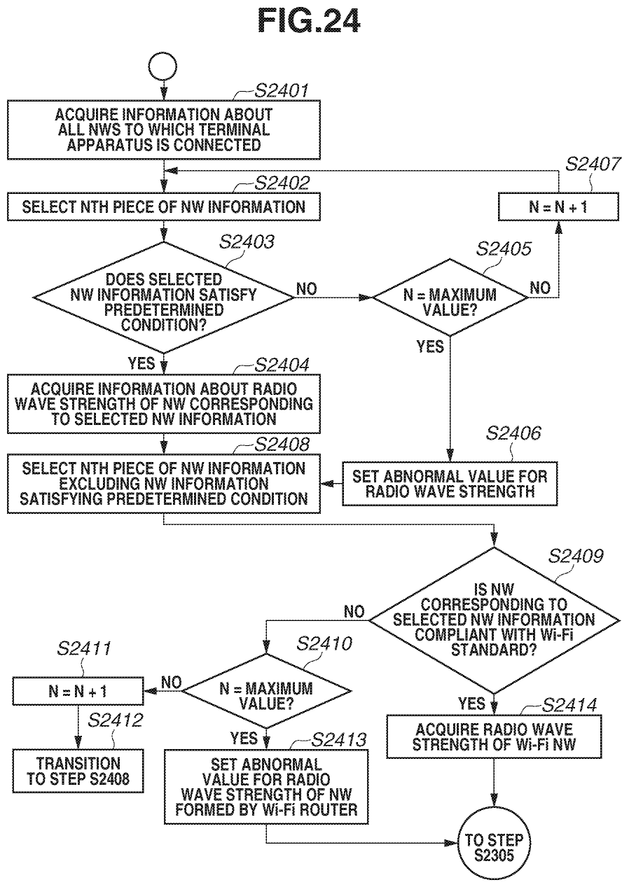

In step S2303, the first application performs processing for acquiring the values related to the radio wave strengths of the plurality of NWs to which the terminal apparatus 101 is connected. Details of this processing will be described with reference to FIG. 24.

The processing of steps S2401 to S2407 is similar to the processing of steps S1903, S1905, S1907, S2104, S1909, S2106, and S1911. A description thereof will thus be omitted.

In step S2408, the first application selects (identifies) one of the plurality of pieces of acquired NW information, excluding the NW information satisfying the predetermined condition. In other words, the first application excludes the NW information satisfying the predetermined condition, and selects (identifies) the Nth piece of NW information among the plurality of pieces of acquired NW information other than the excluded NW information. Specifically, the first application selects (identifies) one of the pieces of NW information other than that about the NW formed by the communication apparatus 151 operating in the connection setup mode. In a case where a NW satisfying the predetermined condition is discovered in step S2403, the first application decreases the maximum value of N by 1 in this processing. In a case where no NW satisfying the predetermined condition is discovered in step S2403, the first application does not decrease the maximum value of N by 1 in this processing. The initial value of N is 1.

In step S2409, the first application checks whether there is another Wi-Fi NW to which the terminal apparatus 101 is connected. Specifically, in this processing, the first application determines whether the NW corresponding to the NW information selected by the first application from among the pieces of NW information except for the NW formed by the communication apparatus 151 operating in the connection setup mode is compliant with the Wi-Fi standard. More specifically, the first application checks whether the NW is a Wi-Fi NW by using an API called “hasTransport”. In a case where, in this processing, the first application determines that the NW is a Wi-Fi NW (YES in step S2409), the processing proceeds to step S2414. In a case where the first application determines that the NW is not a Wi-Fi NW (NO in step S2409), the processing proceeds to step S2410. An example of the NW that is determined to be a Wi-Fi NW in this processing is the NW formed by the AP 131 to which the terminal apparatus 101 is connected.

The processing of steps S2410 and S2411 is similar to the processing of steps S1909 and S1911, and a description thereof will thus be omitted. In a case where, in step S2410, the first application determines that the determination result is yes (YES in step S2410), the processing proceeds to step S2413. In a case where the first application determines that the determination result is no (NO in step S2410), the processing proceeds to step S2411.

In step S2412, the processing transitions to step S2408. In step S2408 that is the transition destination, the first application selects (identifies) the Nth piece of NW information among the plurality of pieces of acquired NW information other than the excluded NW information.

In step S2413, which is performed when the determination result of step S2410 is yes, the first application sets an abnormal value for the radio wave strength of the NW formed by the Wi-Fi router. As employed herein, the abnormal value may be any value that prevents the radio wave strength from being determined to be less than a threshold in the processing of the subsequent step S2305. Specifically, the abnormal value may be a value greater than or equal to the first threshold described in the first embodiment, which is a value based on 50% of the foregoing predetermined value or specific value. A value greater than or equal to a threshold different from the first threshold may be used.

In step S2414, the first application acquires from the OS a value related to the radio wave strength of the Wi-Fi NW. In the present embodiment, the radio wave strength of the Wi-Fi NW is used as the radio wave strength of the AP 131. Specifically, the radio wave strength of the AP 131 refers to the strength of radio waves that are emitted from the AP 131 and received by the terminal apparatus 101. The value related to the radio wave strength acquired from the OS here will be referred to as a third radio wave strength. In the present embodiment, the first application acquires a signal level from the OS. However, such a configuration is not restrictive. Specifically, the first application may acquire from the OS an RSSI value that is a value related to the radio wave strength of the AP 131. The method for acquiring the radio wave strength here is similar to the method of step S2104, with the difference in the specified NW. A description thereof will thus be omitted.

In step S2305, the first application determines whether the strength of the radio waves from the NW of the communication apparatus 151 operating in the connection setup mode is less than a threshold. This processing is similar to the processing of step S2004, and a description thereof will thus be omitted. In a case where, in this processing, the first application determines that the determination result is yes (YES in step S2305), the processing proceeds to step S2306. In a case where the first application determines that the determination result is no (NO in step S2305), the processing proceeds to step S2308.

Step S2306 is similar to step S2005, and a description thereof will thus be omitted.

In step S2307, the first application determines whether the button 2202 for continuing the connection setup processing is operated. In a case where the first application determines that the determination result is yes (YES in step S2307), the processing proceeds to step S2308. In a case where the first application determines that the determination result is no (NO in step S2307), the processing proceeds to step S2307.

In step S2308, the first application determines whether the radio wave strength of the Wi-Fi NW acquired in step S2414 is less than a threshold. In a case where the determination result is yes (YES in step S2308), the processing proceeds to step S2309. In a case where the determination result is no (NO in step S2308), the processing proceeds to step S2313. The threshold used in this determination may be the first threshold used in the determinations of steps S1202 and S2305 or a third threshold that is a different threshold.

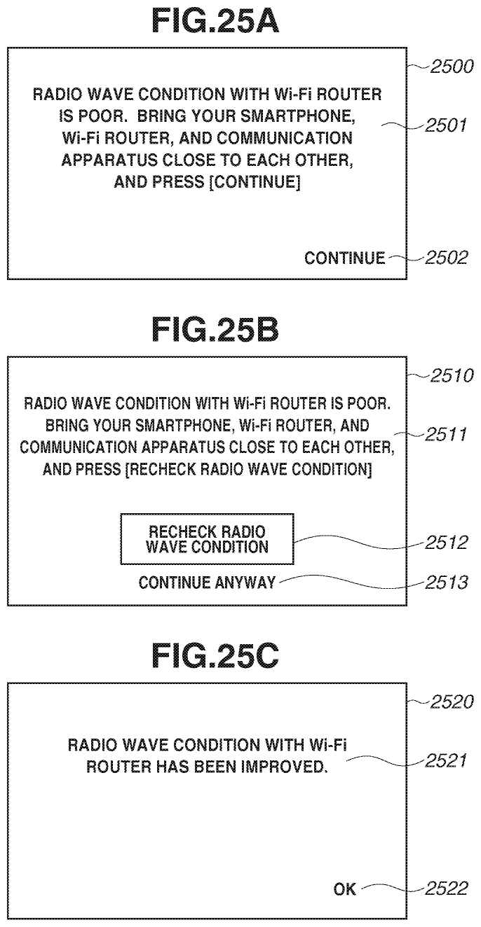

In step S2309, the first application displays a notification screen for notifying the user to bring the AP 131 and the terminal apparatus 101 close to each other. FIG. 25A illustrates an example of the notification screen displayed in this processing. A screen 2500 is a notification screen for notifying the user to bring the AP 131, the terminal apparatus 101, and the communication apparatus 151 close to each other. The screen 2500 includes an area 2501 displaying text for notifying the user to bring the AP 131, the terminal apparatus 101, and the communication apparatus 151 close to each other, and a button 2502 for continuing the connection setup processing. The area 2501 displays text indicating that the third radio wave strength is weak, and text for prompting the user to bring the AP 131, the communication apparatus 151, and the terminal apparatus 101 close to each other and continue the connection setup processing. The radio wave condition in this processing corresponds to the radio wave condition of the wireless communication between the AP 131 and the terminal apparatus 101. The reason why the user is notified to also bring the communication apparatus 151 closer is that as a result of bringing the AP 131 and the terminal apparatus 101 close to each other, the distance from the communication apparatus 151 may increase with a degradation in the radio wave condition of the wireless communication between the terminal apparatus 101 and the communication apparatus 151. In the present embodiment, the radio wave condition is determined to be poor in a case where the third radio wave strength acquired in step S2414 is less than the first threshold or the third threshold. In other words, the poor radio wave condition corresponds to the third radio wave strength being weak. In a case where the user wants to continue the connection setup processing, the user operates the button 2502 for continuing the connection setup processing.

In the case of the primary NW, a screen 2510 with a reacquisition button such as illustrated in FIG. 25B may be displayed since the radio wave strength can be updated. The screen 2510 includes an area 2511 displaying text for notifying the user to bring the AP 131, the terminal apparatus 101, and the communication apparatus 151 close to each other, a button 2512 for rechecking the radio wave condition, and a button 2513 for continuing the connection setup processing. The area 2511 displays text indicating that the third radio wave strength is weak, and text for prompting the user to bring the AP 131, the communication apparatus 151, and the terminal apparatus 101 close to each other and recheck the radio wave condition. In a case where the user wants to recheck the radio wave condition, the user operates the button 2512 for rechecking the radio wave condition.

In step S2310, the first application determines whether the button 2512 for rechecking the radio wave condition is operated. In a case where the first application determines that the determination result is yes (YES in step S2310), the processing proceeds to step S2311. In a case where the first application determines that the determination result is no (NO in step S2310), the processing proceeds to step S2312. In a case where the button 2512 for rechecking the radio wave condition is absent (in the case where the screen 2500 of FIG. 25A is displayed), the processing of step S2310 is skipped, and the processing proceeds to step S2312.

In step S2311, the first application acquires the radio wave strength of the AP 131 again. Here, the first application may simply perform the processing of step S2414. For NW specification here, the NW information specified in the processing of step S2414 may be stored within the first application. In other words, the first application acquires the NW capability information from the stored NW information again, and refers to the radio wave strength. Alternatively, the first application may perform the processing of step S2303 again to acquire the radio wave strength again without storing the NW information within the application.

In step S2312, the first application determines whether the button 2502 or 2513 for continuing the connection setup processing is operated. In a case where the first application determines that the determination result is yes (YES in step S2312), the processing of this flowchart ends. In a case where the first application determines that the determination result is no (NO in step S2312), the processing returns to S2310.

In step S2313, the first application determines whether the screen 2500 or the screen 2510 is displayed. In a case where the determination result is yes (YES in step S2313), the processing proceeds to step S2314. In a case where the determination result is no (NO in step S2313), the processing of this flowchart ends. In the case where the screen 2500 without the reacquisition button is displayed, the processing of steps S2310, S2311, S2313, and S2314 is skipped.

In step S2314, the first application displays a screen for notifying that the radio wave strength of the AP 131 has been improved. FIG. 25C illustrates an example of the screen displayed in this processing. A screen 2520 is a notification screen for notifying the user that the radio wave strength between the AP 131 and the terminal apparatus 101 has been improved. The screen 2520 includes an area 2521 displaying text for notifying the user that the radio wave strength between the AP 131 and the terminal apparatus 101 has been improved, and a button 2522 for continuing the connection setup processing. In a case where the user wants to continue the connection setup processing, the user operates the button 2522 for continuing the connection setup processing. In a case where the button 2522 for continuing the connection setup processing is pressed, this flowchart ends.

The notification screen displayed in step S2005 may be the screen 1300 with the button for rechecking the radio wave condition. In such a case, in a case where the button 1302 for rechecking the radio wave condition is pressed, the radio wave condition is rechecked using the OS's Wi-Fi scan. Specifically, the first application initially instructs the OS to search for the communication apparatus 151 operating in the connection setup mode. The first application then acquires the information about the search result of the OS by calling an API based on program code “getScanResults”. Based on the communication apparatus 151 being discovered from the information, the first application may consult the information for a value related to the radio wave strength of the communication apparatus 151. The value is an RSSI value. The first application refers to the RSSI value, and calls an API based on the program code “calculateSignalLevel” to convert the RSSI value into a signal level value. The foregoing value may be a signal level.

There is a limitation that the Wi-Fi scan can only be performed four times in two minutes on Android 9 or later. When the button 1302 for rechecking the radio wave condition is pressed, the first application therefore initially determines whether the foregoing limit is exceeded, and in a case where the determination result is no, executes the Wi-Fi scan to acquire the radio wave strength. In a case where the determination result of whether the limit is exceeded is yes, the first application performs processing for the case where the limit is exceeded. An example of the processing here is displaying a notification screen notifying that the limit is exceeded.

The first application may display a screen for waiting until the Wi-Fi scan becomes executable again.

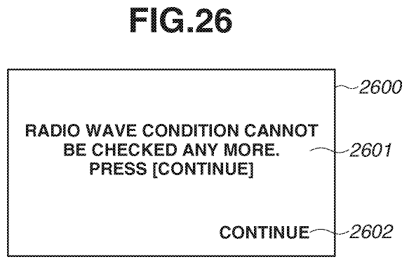

FIG. 26 illustrates an example of the notification screen for notifying that the limit is exceeded. A screen 2600 includes an area 2601 indicating that the radio wave condition is unable to be checked because the number of times limit is exceeded, and a button 2602 for continuing the connection setup processing. In a case where the user wants to continue the connection setup processing, the user operates the button 2602 for continuing the connection setup processing. In a case where the button 2602 for continuing the connection setup processing is pressed, this flowchart ends.

According to the foregoing processing, the radio wave strength corresponding to the information about the NW stored in advance as the partner for the first application to transmit information to among the connected NWs in the processing of steps S2101 to S2107 can be acquired, regardless of whether a primary NW or a secondary NW. For example, appropriate radio wave strength can be displayed even in the following cases (1) and (2):
(1) The terminal apparatus 101 connects to a secondary NW under instructions from another application different from the first application. The first application then issues an instruction to connect to the same NW, but the OS stores not the first application but another application having first issued the connection instruction in association with the connection-instructed NW.
(2) The conventional mechanism is no longer provided in which the OS, when NW connection is instructed by an application, stores the connecting-instructing application and the connection-instructed NW (secondary NW) in association with each other.

In the present embodiment, the method for acquiring the radio wave strength is switched in the processing of steps S2002, S2003, and S2007, depending on whether the terminal apparatus 101 supports the STA/STA function. In a case where the terminal apparatus 101 does not support the STA/STA function, the first application acquires the radio wave strength corresponding to the Wi-Fi NW to which the terminal apparatus 101 is connected (NW of the communication apparatus 151). On the other hand, in a case where the terminal apparatus 101 supports the STA/STA function, the first application identifies the NW of the communication apparatus 151 operating in the connection setup mode among the plurality of NWs to which the terminal apparatus 101 is connected, and acquires the radio wave strength of the identified NW. In other words, when acquiring the radio wave strength in the case where the terminal apparatus 101 does not support the STA/STA function, the processing for identifying the NW of the communication apparatus 151 operating in the connection setup mode from among the plurality of NWs is not needed.

In a case where the terminal apparatus 101 does not support the STA/STA function, the method for acquiring the radio wave strength is thus switched as described above, rather than using the method for acquiring the radio wave strength in the case where the terminal apparatus 101 supports the STA/STA function.

### Other Embodiments

The foregoing embodiments have dealt with a configuration where the connection between the communication apparatus 151 operating in the connection setup mode and the terminal apparatus 101 is a Wi-Fi connection. However, such a configuration is not restrictive. The connection between the communication apparatus 151 operating in the connection setup mode and the terminal apparatus 101 may be established using communication methods other than Wi-Fi, such as Bluetooth® Classic and Bluetooth® Low Energy. In such a case, the terminal apparatus 101 may maintain a Wi-Fi connection with the predetermined AP even when establishing the connection between the communication apparatus 151 operating in the connection setup mode and the terminal apparatus 101. More specifically, in the configuration where the connection between the communication apparatus 151 operating in the connection setup mode and the terminal apparatus 101 is a Wi-Fi connection, the predetermined AP is connected with the terminal apparatus 101 when the processing triggering the flowcharts of FIGS. 3A and 3B is performed. The predetermined AP is not connected with the terminal apparatus 101 during step S313 or S326. By contrast, when the connection between the communication apparatus 151 operating in the connection setup mode and the terminal apparatus 101 is other than a Wi-Fi connection, the predetermined AP is the AP connected with the terminal apparatus 101 both when the foregoing triggering processing is performed and during steps S313 and S326. The predetermined AP can thus be said to be an AP to which the terminal apparatus 101 is connected at least when the processing triggering the flowcharts of FIGS. 3A and 3B is performed.

In the foregoing embodiments, the processing for checking the radio wave strength of the connection setup AP may be performed before the connection setup AP is connected with the terminal apparatus 101. Specifically, the first application initially instructs the OS to search for the communication apparatus 151 operating in the connection setup mode. The first application then acquires the information about the search result of the OS by calling the API based on the program code “getScanResults”. Based on the communication apparatus 151 being discovered from the information, the first application may consult the information for a value related to the radio wave strength of the communication apparatus 151. This value is an RSSI value. The first application refers to the RSSI value and calls the API based on the program code “calculateSignalLevel” to convert the RSSI value into a signal level value. The foregoing value may be a signal level.

In the foregoing embodiments, the processing for checking the radio wave strength of the AP identified to be the connection target of the communication apparatus 151 may be performed after step S308 or S312. In other words, the processing for checking the radio wave strength of the AP identified to be the connection target of the communication apparatus 151 may be performed even in a case where the predetermined AP or the specific AP is identified to be the connection target of the communication apparatus 151.

In the foregoing embodiments, the processing for referring to the specific AP does not necessarily need to be performed. Specifically, for example, the processing of steps S301 and S309 to S313 may be omitted. In such a configuration, in a case where the determination result of step S306 is no, the processing proceeds to step S314. In a case where the determination result of step S308 is yes, the processing proceeds to step S321.

In the foregoing embodiments, neither of the processing for referring to the predetermined AP and the processing for referring to the specific AP necessarily needs to be performed. Specifically, for example, the processing of steps S301, S302, and S306 to S313 may be omitted. In such a configuration, step S314 is performed after step S305.

In the foregoing embodiments, the screen displayed in step S315 does not need to display the direct connection button. Specifically, for example, the processing of steps S315 to S318 may be omitted. In such a configuration, step S319 is performed after step S314.

Suppose, in the foregoing embodiments, the OS of the terminal apparatus 101 is a version capable of displaying the password on the Wi-Fi setup screen using the second application. Even in such a case, all the buttons 503, 504, and 505 do not necessarily need to be displayed on the password input screen 500 displayed in step S321. Specifically, in such a configuration, the password input screen 500 displayed in step S321 may simply display at least one of the button 503 for password check by the first method, the button 504 for password check by the second method, and the button 505 for another connection method.

In the foregoing embodiments, the password input screen 500 displays the button 503 for password check by the first method as an area for password check by the first method.

A new screen for password check by the first method is then described to be displayed when the button is operated. However, such a configuration is not restrictive. As the area for password check by the first method, an area including text describing a specific password checking method may be displayed on the password input screen 500. In other words, the content displayed on the screen for password check by the first method in the foregoing embodiments may be displayed on the password input screen 500. The content may be displayed on a new screen that is separately displayed before the password input screen 500 is displayed. In such a configuration, the button 503 for password check by the first method does not need to be displayed on the password input screen 500.

The foregoing embodiments have dealt with a configuration where the button 504 for password check by the second method is displayed on the password input screen 500, and a new screen for password check by the second method is displayed when the button 504 is operated. However, such a configuration is not restrictive.

As an area for password check by the second method, an area including text describing a specific password checking method may be displayed on the password input screen 500. In other words, the content displayed on the screen for password check by the second method in the foregoing embodiments may be displayed on the password input screen 500. The content may be displayed on a new screen that is separately displayed before the password input screen 500 is displayed. In such a configuration, the button 504 for password check by the second method does not need to be displayed on the password input screen 500.

In the foregoing embodiments, the screen for password check by the first method may display text describing a specific password checking method as the area for password check by the second method.

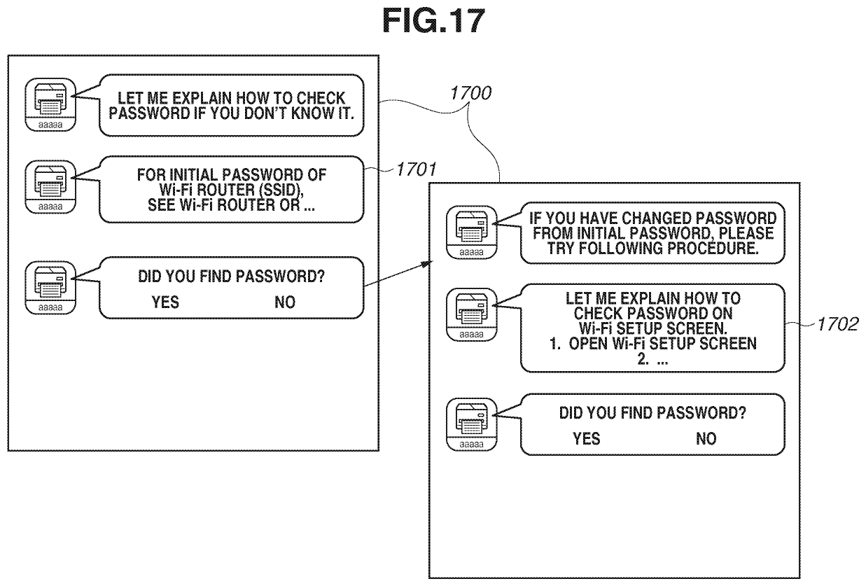

In the foregoing embodiments, in a case where the connection setup processing is executed in a chatbot form, the screen for password check by the second method may be displayed in a chatbot form illustrated in FIG. 17. Specifically, the first application displays a method for checking the Wi-Fi router for the password in an area 1701. Based on the user operating a button indicating that the user is unable to find the password on the Wi-Fi router, the first application then describes a method for checking the password on the Wi-Fi setup screen in an area 1702. The first application then has the user select whether they have successfully checked the password on the Wi-Fi setup screen. In a case where a button indicating that the user has successfully checked the password is operated, the first application displays an area for password input. In a case where a button indicating that the user has failed to check the password is operated, the first application introduces another connection method. The description of the method for checking the password on the Wi-Fi setup screen may be displayed immediately after the description of the method for checking the Wi-Fi router for the password.

The foregoing embodiments have dealt with a configuration where the button 505 for another connection method is displayed on the password input screen 500 as an area for another connection method, and when the button is operated, a new screen for another connection method is displayed. However, such a configuration is not restrictive. As the area for another connection method, an area including text describing another connection method may be displayed on the password input screen 500. In other words, the content displayed for the method for another connection method in the foregoing embodiments may be displayed on the password input screen 500. The content may be displayed on a new screen that is separately displayed before the password input screen 500 is displayed. In such a configuration, the button 505 for another connection method does not need to be displayed on the password input screen 500.

In the foregoing embodiments, the button 1102 for password check by the first method is displayed on the screen 1100 for password check by the second method as an area for password check by the first method. A new screen for password check by the first method is described to be displayed in a case where the button 1102 is operated. However, such a configuration is not restrictive. As the area for password check by the first method, an area including text describing the specific password checking method may be displayed on the screen 1100 for password check by the second method. In other words, the content displayed on the screen for password check by the first method in the foregoing embodiments may be displayed on the screen 1100 for password check by the second method.

In the foregoing embodiments, the button 1103 for another connection method is displayed on the screen 1100 for password check by the second method as an area for another connection method. A new screen for another connection method is described to be displayed in a case where the button 1103 is operated. However, such a configuration is not restrictive. As the area for another connection method, an area including text describing another connection method may be displayed on the screen 1100 for password check by the second method. In other words, the content displayed on the screen for another connection method in the foregoing embodiments may be displayed on the screen 1100 for password check by the second method.

In the foregoing embodiments, the order of the determinations of steps S322 to S329 is not limited in particular. The determinations of steps S322 to S329 may be performed in arbitrary order.

In the foregoing embodiments, the AP list used in the determinations of steps S306 and S310 and displayed in step S314 is described to be a list of APs discovered by a search performed by the communication apparatus 151. However, such a configuration is not restrictive. In a case where the notification screen corresponding to the state in which the second radio wave strength is less than the second threshold is not displayed in step S320, the AP list may be a list of APs discovered by a search performed by the terminal apparatus 101. In such a configuration, the processing of step S305 may be omitted.

In the foregoing embodiments, the processing for referring to whether the initial setting operations on the communication apparatus 151 have been completed does not necessarily need to be performed. Specifically, for example, the processing of steps S702 to S706 may be omitted. In such a configuration, step S707 is performed after step S701.

In the foregoing embodiments, even in a case where the terminal apparatus 101 is a terminal apparatus supporting the STA/STA function, the first API, second API, and third API used in step S1201 may be used.

According to the present disclosure, the usability of an application program that performs processing for transmitting information for connecting to an AP to a communication apparatus can be improved.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2025-057899, filed Mar. 31, 2025, and No. 2025-128159, filed Jul. 31, 2025, which are hereby incorporated by reference herein in their entirety.

What is claimed is:

1. A non-transitory computer-readable storage medium storing a program for causing a computer of an information processing apparatus to execute a process comprising:
performing, as first display control, control to display a list related to information about one or more external apparatuses discovered by a search performed by a communication apparatus;
accepting a user selection of a connection target of the communication apparatus from the list;
performing, as second display control, in a case where a predetermined condition corresponding to a state in which a first radio wave condition for wireless communication between a first external apparatus selected by the user and the communication apparatus is poor is not satisfied, control not to display a first notification screen indicating that the first radio wave condition is poor, before setting information for connecting to the first external apparatus is transmitted to the communication apparatus, and in a case where the predetermined condition is satisfied, control to display the first notification screen before the setting information is transmitted to the communication apparatus; and
performing, as first control, control to transmit the setting information to the communication apparatus.

2. The storage medium according to claim 1, wherein in a case where the setting information is received by the communication apparatus, the communication apparatus is connected to the first external apparatus using the setting information.

3. The storage medium according to claim 1,
wherein the process further comprises performing, as third display control, control to display an input screen for accepting input of the setting information from the user, and
wherein the first notification screen is displayed before the setting information is input to the input screen.

4. The storage medium according to claim 1, wherein the first notification screen includes at least one of content indicating that the first radio wave condition is poor and content indicating a change in a positional relationship between the first external apparatus and the communication apparatus.

5. The storage medium according to claim 4, wherein the content indicating a change in the positional relationship between the first external apparatus and the communication apparatus is content prompting the first external apparatus and the communication apparatus to be brought closer to each other.

6. The storage medium according to claim 1,
wherein the first notification screen includes a first item for continuing a connection setting of the communication apparatus, and
wherein in a case where the first item is operated, processing for transmitting the setting information to the communication apparatus via connection between the information processing apparatus and the communication apparatus is performed.

7. The storage medium according to claim 1,
wherein the first notification screen includes a second item for accepting an instruction to acquire information indicating the first radio wave condition again, and
wherein in a case where the second item is operated and the predetermined condition is satisfied, the first notification screen is displayed again.

8. The storage medium according to claim 1, wherein an area indicating a radio wave condition for wireless communication between each of the one or more external apparatuses and the communication apparatus is displayed in the list.

9. The storage medium according to claim 1, wherein the information about the one or more external apparatuses is displayed in the list based on predetermined information indicating a radio wave condition for wireless communication between each of the one or more external apparatuses and the communication apparatus.

10. The storage medium according to claim 9, wherein information about the one or more external apparatuses is displayed in the list in descending order of the radio wave condition for the wireless communication between each of the one or more external apparatuses and the communication apparatus.

11. The storage medium according to claim 1,
wherein the process further comprises acquiring predetermined information indicating a radio wave condition for wireless communication between each of the one or more external apparatuses and the communication apparatus, and
wherein the predetermined information is information corresponding to a strength of a radio wave that has been emitted from each of the one or more external apparatuses and received by the communication apparatus.

12. The storage medium according to claim 11, wherein the predetermined condition includes a condition that a value corresponding to the strength of the radio wave, emitted from the first external apparatuses and received by the communication apparatus, is less than a threshold, the strength being indicated by the predetermined information.

13. The storage medium according to claim 1,
wherein the process further comprises:
acquiring, as second acquiring, information about a second radio wave condition between the information processing apparatus and the communication apparatus; and
performing, as fourth display control, control to display a second notification screen indicating that the second radio wave condition is poor, based on the information about the second radio wave condition.

14. The storage medium according to claim 1, wherein the process further comprises performing, as second transmitting, control to transmit at least one of a print job for causing the communication apparatus to perform printing and a scan job for causing the communication apparatus to perform a scan, from the information processing apparatus to the communication apparatus via the first external apparatus connected using the setting information.

15. The storage medium according to claim 1, wherein the wireless communication is performed by a communication method based on an Institute of Electrical and Electronics Engineers (IEEE) 802.11 series standard.

16. The storage medium according to claim 1, wherein the setting information is transmitted to the communication apparatus without passing through the first external apparatus.

17. A non-transitory computer-readable storage medium storing a program configured to cause a computer of an information processing apparatus to execute a process comprising:
accepting a user selection of an external apparatus serving as a connection target from a list including information indicating one or more external apparatuses searched by a communication apparatus; and
performing, in a case where a first external apparatus is selected as the connection target from the list, and a first condition corresponding to a state in which a first radio wave condition for wireless communication between the first external apparatus serving as the connection target and the communication apparatus is poor is satisfied, control to transmit setting information for connecting to the first external apparatus to the communication apparatus after displaying a first notification screen indicating that the first radio wave condition is poor, and in a case where a second external apparatus to which the information processing apparatus is connected when a predetermined instruction to perform wireless setting of the communication apparatus is accepted is identified as the connection target, control to transmit the setting information to the communication apparatus without displaying the first notification screen regardless of whether the first condition is satisfied.

18. The storage medium according to claim 17, wherein the control is configured to perform, in a case where the second external apparatus is identified as the connection target without an external apparatus being selected by the user as the connection target from the list, control to transmit the setting information to the communication apparatus without displaying the first notification screen, regardless of whether the first condition is satisfied.

19. A control method for an information processing apparatus comprising:
displaying, as first display control, a list related to information about one or more external apparatuses discovered by a search performed by a communication apparatus;
accepting a user selection of a connection target of the communication apparatus from the list;
performing, as second display control, in a case where a predetermined condition corresponding to a state in which a first radio wave condition for wireless communication between a first external apparatus selected by the user and the communication apparatus is poor is not satisfied, control not to display a first notification screen indicating that the first radio wave condition is poor, before setting information for connecting to the first external apparatus is transmitted to the communication apparatus, and in a case where the predetermined condition is satisfied, control to display the first notification screen before the setting information is transmitted to the communication apparatus; and
performing, as first control, control to transmit the setting information to the communication apparatus.

20. An information processing apparatus comprising,
at least one memory and at least one processor which function as:
a first display control unit configured to display a list related to information about one or more external apparatuses discovered by a search performed by a communication apparatus;
an acceptance unit configured to accept a user selection of a connection target of the communication apparatus from the list;
a second display control unit configured to perform, in a case where a predetermined condition corresponding to a state in which a first radio wave condition for wireless communication between a first external apparatus selected by the user and the communication apparatus is poor is not satisfied, control not to display a first notification screen indicating that the first radio wave condition is poor, before setting information for connecting to the first external apparatus is transmitted to the communication apparatus, and in a case where the predetermined condition is satisfied, control to display the first notification screen before the setting information is transmitted to the communication apparatus; and
a first control unit configured to perform control to transmit the setting information to the communication apparatus.
